(19) United States
(12) Patent Application Publication
(10) Pub. No.: US 2025/0266975 A1
(43) Pub. Date: Aug. 21, 2025

(54) SBFD-AWARE UE BEHAVIOR IN SFI-FL SYMBOL WITH UL-SB

(71) Applicant: QUALCOMM Incorporated, San Diego, CA (US)

(72) Inventors: Muhammad Sayed Khairy ABDELGHAFFAR, San Jose, CA (US); Abdelrahman Mohamed Ahmed Mohamed IBRAHIM, San Diego, CA (US); Qian ZHANG, Basking Ridge, NJ (US)

(21) Appl. No.: 18/443,201

(22) Filed: Feb. 15, 2024

(51) Int. Cl. H04L 5/14; H04L 5/00; H04W 72/0446

(52) U.S. Cl. CPC H04L 5/14; H04L 5/0048; H04W 72/0446

(57) ABSTRACT

This disclosure provides approaches for managing sub-band full duplex (SBFD)-aware user equipment (UE) behaviors in SBFD flexible symbols having an uplink sub-band. The proposed methods and apparatuses enhance the efficiency of wireless communication by dynamically adjusting SBFD-aware UE behaviors in response to the presence or absence of Downlink Control Information (DCI) including a Slot Format Indicator (SFI). The SFI is configured to indicate a slot format for either only the flexible resources associated with a SBFD symbol of the set of SBFD symbols, or the SBFD symbol including both the flexible resources and the uplink resources. Methods of wireless communication performable at a UE are accordingly provided which monitor for such DCI, and then receive or transmit, or refrain from receiving or transmitting, data in the SBFD symbols according to one of a plurality of behaviors respectively based on a detected presence or a detected absence of the DCI.

### TECHNICAL FIELD

The present disclosure generally relates to wireless communication, and more particularly, to wireless communication systems that manage sub-band full duplex (SBFD)-aware user equipment (UE) behaviors in SBFD flexible symbols having an uplink sub-band.

### DESCRIPTION OF THE RELATED TECHNOLOGY

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

One innovative aspect of the subject matter described in this disclosure may be implemented in an apparatus for wireless communication, which may be a user equipment (UE). The apparatus includes one or more memories, and one or more processors each communicatively coupled with at least one of the one or more memories. The one or more processors, individually or in any combination, are operable to cause the apparatus to monitor for downlink control information (DCI) including a slot format indication (SFI) for a set of sub-band full duplex (SBFD) symbols in a slot, the set of SBFD symbols respectively being associated with flexible resources in at least one flexible sub-band and uplink resources in an uplink (UL) sub-band, and the SFI being configured to indicate a downlink format, an uplink format, or a flexible format for one of: only the flexible resources associated with a SBFD symbol of the set of SBFD symbols, or the SBFD symbol including both the flexible resources and the uplink resources; and receive or transmit, or refrain from receiving or transmitting, data in the SBFD symbol according to at least one of a plurality of behaviors respectively based on a detected presence or a detected absence of the DCI.

Another innovative aspect of the subject matter described in this disclosure may be implemented in a method for wireless communication performable at a UE. The method includes monitoring for DCI including a SFI for a set of SBFD symbols in a slot, the set of SBFD symbols respectively being associated with flexible resources in at least one flexible sub-band and uplink resources in an UL sub-band, and the SFI being configured to indicate a downlink format, an uplink format, or a flexible format for one of: only the flexible resources associated with a SBFD symbol of the set of SBFD symbols, or the SBFD symbol including both the flexible resources and the uplink resources; and receiving or transmitting, or refraining from receiving or transmitting, data in the SBFD symbol according to at least one of a plurality of behaviors respectively based on a detected presence or a detected absence of the DCI.

Another innovative aspect of the subject matter described in this disclosure may be implemented in an apparatus for wireless communication, which may be a UE. The apparatus includes means for monitoring for DCI including a SFI for a set of SBFD symbols in a slot, the set of SBFD symbols respectively being associated with flexible resources in at least one flexible sub-band and uplink resources in an UL sub-band, and the SFI being configured to indicate a downlink format, an uplink format, or a flexible format for one of: only the flexible resources associated with a SBFD symbol of the set of SBFD symbols, or the SBFD symbol including both the flexible resources and the uplink resources; and means for receiving or transmitting, or for refraining from receiving or transmitting, data in the SBFD symbol according to at least one of a plurality of behaviors respectively based on a detected presence or a detected absence of the DCI.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1A is a diagram illustrating an example of a wireless communications system and an access network.

FIG. 1B shows a diagram illustrating an example disaggregated base station architecture.

FIG. 2A is a diagram illustrating an example of a first subframe within a 5G NR frame structure.

FIG. 2B is a diagram illustrating an example of DL channels within a 5G NR subframe.

FIG. 2C is a diagram illustrating an example of a second subframe within a 5G NR frame structure.

FIG. 2D is a diagram illustrating an example of UL channels within a 5G NR subframe.

FIG. 3 is a block diagram illustrating an example of a base station and a UE involved in wireless communication.

FIG. 4 is a block diagram illustrating an example of a DCI having DCI format 2_0.

FIG. 5 is a block diagram illustrating an example of uplink collision handling between uplink (UL) data transmissions configured by higher-layers and dynamic grant (DG)-downlink transmissions in slot format indicator (SFI)-flexible (FL)/downlink (DL) symbols.

FIG. 6 is a block diagram illustrating an example where a UE is configured to, but does not detect, a DCI format 2_0.

FIG. 7 is a block diagram illustrating an example of flexible symbols in a slot following conversion to sub-band full duplex (SBFD) symbols and their interaction with SFI.

FIG. 8 is a block diagram illustrating an example where a UE is configured with a set of sub-bands including FL resources and UL resources in SBFD symbols.

FIG. 9 is a block diagram illustrating an example where the UE detects SFI in DCI format 2_0 in SBFD flexible symbols but the SFI is applicable to the whole symbol rather than only the flexible sub-bands.

FIG. 10 is a block diagram illustrating an example where the UE does not detect SFI indicated in DCI format 2_0 in SBFD flexible symbols.

FIG. 11 is a diagram illustrating an example of a call flow between a base station and a UE.

FIG. 12 is a flowchart of an example method of wireless communication performable at a UE.

FIG. 13 is a diagram illustrating an example of a hardware implementation for an apparatus that may be a UE.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that may be accessed by a computer. By way of example, and not limitation, such computer-readable media may comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that may be used to store computer executable code in the form of instructions or data structures that may be accessed by a computer.

Generally for wireless communication, a UE may receive a time division duplex (TDD) downlink or uplink configuration indicating a downlink, uplink, or flexible format for a set of symbols in a slot. If the TDD configuration indicates a flexible format for these symbols, or if the UE does not receive such TDD configuration and thus assumes these symbols are flexible, the UE may monitor for a downlink control information (DCI) format 2_0 including a slot format indicator (SFI) indicating a slot format for these flexible symbols in the slot. Based on whether or not the UE detects the DCI and whether the slot format indicated in SFI is downlink, uplink, or flexible, the UE may perform one of various reception or transmission behaviors for data configured or scheduled within this set of symbols.

However, in some cases, a UE may also receive a sub-band full duplex (SBFD) configuration indicating one or more flexible sub-bands and an uplink sub-band in this set of flexible symbols. In such cases, when a SBFD-aware UE is configured to monitor for the DCI format 2_0 indicating a SFI for these SBFD flexible symbols, then whether or not the UE detects or does not detect the DCI, the interpretation of the slot format or SFI for these SBFD flexible symbols and the subsequent behavior of the UE are not clearly defined. This may lead to potential inefficiencies in wireless communication. To address this issue, aspects of the present disclosure provide clear guidelines for UE behavior in scenarios involving SBFD flexible symbols. In particular, multiple sets of behaviors are provided that the UE may follow based on whether the UE detects or fails to detect the DCI format 2_0, based on whether the SFI applies to the whole SBFD symbol or only to the flexible sub-bands within the symbol, and based on the slot format indicated in the SFI. Thus, the efficiency of wireless communication systems in SBFD symbols may be enhanced for SBFD-aware UEs.

Accordingly, various aspects of the subject matter described in this disclosure relate generally to wireless communication and more particularly to management of SBFD-aware UE behaviors in SBFD flexible symbols having an uplink sub-band. Some aspects specifically relate to the interpretation of SFIs within DCI format 2_0 and the subsequent behavior of the UE in scenarios involving SBFD flexible symbols. In some examples, apparatuses and methods are provided in which a UE monitors for DCI including an SFI for a set of SBFD symbols in a slot, the set of SBFD symbols respectively being associated with flexible resources in at least one flexible sub-band and uplink resources in an uplink sub-band. The SFI is configured to indicate a downlink format, an uplink format, or a flexible format for either only the flexible resources associated with a SBFD symbol of the set of SBFD symbols, or the SBFD symbol including both the flexible resources and the uplink resources. The UE then receives or transmits, or refrains from receiving or transmitting, data in the SBFD symbol according to at least one of a plurality of behaviors respectively based on a detected presence or a detected absence of the DCI. Additional aspects relate to the specific behaviors of the UE based on the SFI configuration and the detected presence or absence of the DCI. These behaviors may include, for example, reception or transmission of data in the flexible resources or the SBFD symbols, refraining from receiving or transmitting data and SBFD-specific data in the flexible resources or the SBFD symbols, and managing collisions between downlink and uplink data in the flexible resources or the SBFD symbols. Further aspects relate to the UE's behavior when the SFI is configured to indicate a specific format (downlink, uplink, or flexible) for either the flexible resources only, or the entire SBFD symbol including both the flexible resources and the uplink resources. The UE's behavior may also be influenced by a radio resource control (RRC) configuration parameter or a field in the DCI, either of which may indicate whether the SFI applies to only the flexible resources or the entire SBFD symbol.

Thus, particular aspects of the subject matter described in this disclosure may be implemented to realize one or more potential advantages. For example, the proposed methods and apparatuses may provide a more efficient management of wireless communication by managing and dynamically adjusting SBFD-aware UE behaviors in response to the presence or absence of DCI. This may be achieved by configuring the UE to monitor for DCI including an SFI for a set of SBFD symbols in a slot, and then configuring the UE to receive or transmit, or refrain from receiving or transmitting, data in the SBFD symbols according to one of a plurality of behaviors respectively based on a detected presence or a detected absence of the DCI. In addition, the proposed methods and apparatuses may configure the UE to adapt its different reception, transmission, refrained reception, or refrained transmission behaviors based on a specific SFI configuration indicated in DCI for SBFD flexible symbols, thereby enhancing the flexibility and efficiency of wireless communication. For example, depending on whether the SFI indicates these symbols are downlink, uplink, or flexible, the UE may adapt its behaviors accordingly. The proposed methods and apparatus may also specify how the UE may manage collisions between downlink and uplink data in the flexible resources or the SBFD symbols, improving the reliability of the communication system. Furthermore, the proposed methods and apparatuses may provide additional flexibility in the UE's behavior by providing different sets of UE behaviors depending on whether the SFI is configured to indicate a specific format for either the flexible resources only, or the entire SBFD symbol, leading to improved performance of the wireless communication system. To this end, the influence of a RRC configuration parameter or a field in the DCI on the UE's behavior, by indicating how the UE is to interpret the SFI, may provide an additional layer of control, further enhancing the adaptability and efficiency of the wireless communication system. Thus, the proposed methods and apparatuses may lead to optimized utilization of SBFD flexible symbols that include an uplink sub-band.

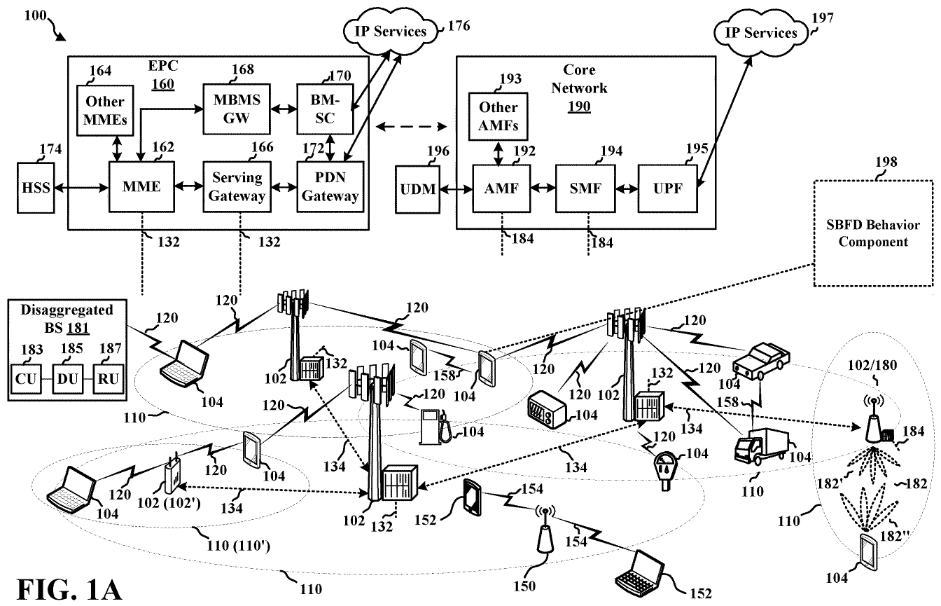

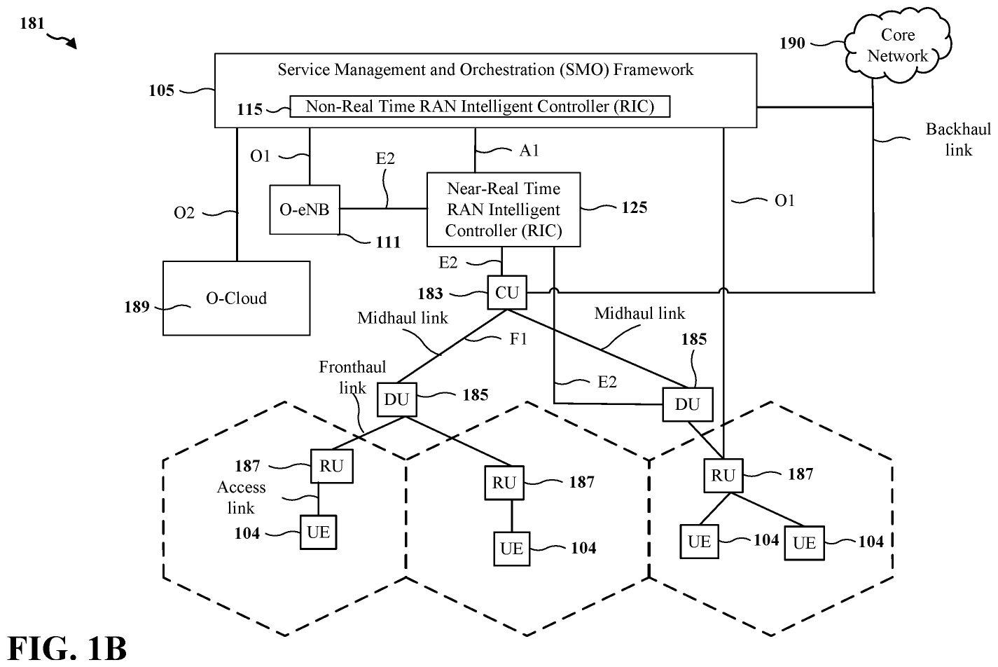

FIG. 1A is a diagram illustrating an example of a wireless communications system and an access network 100. The wireless communications system (also referred to as a wireless wide area network (WWAN)) includes base stations 102, user equipment(s) (UE) 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G New Radio (NR) (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, Multimedia Broadcast Multicast Service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHZ, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHZ). The frequencies between FR1 and FR2 are often referred to as mid-band frequencies. Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QOS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a Packet Switch (PS) Streaming Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Deployment of communication systems, such as 5G NR systems, may be arranged in multiple manners with various components or constituent parts. In a 5G NR system, or network, a network node, a network entity, a network device, a mobility element of a network, a RAN node, a core network node, a network element, or a network equipment, such as a BS, or one or more units (or one or more components) performing base station functionality, may be implemented in an aggregated or disaggregated architecture. For example, a BS (such as a Node B (NB), eNB, NR BS, 5G NB, access point (AP), a TRP, or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station 181 may be configured to utilize a protocol stack that is physically or logically distributed among two or more units (such as one or more central units (CU), one or more distributed units (DUs), or one or more radio units (RUs)). In some aspects, a CU 183 may be implemented within a RAN node, and one or more DUs 185 may be co-located with the CU, or alternatively, may be geographically or virtually distributed throughout one or multiple other RAN nodes. The DUs may be implemented to communicate with one or more RUs 187. Each of the CU, DU and RU also may be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which may enable flexibility in network design. The various units of the disaggregated base station, or disaggregated RAN architecture, may be configured for wired or wireless communication with at least one other unit.

FIG. 1B shows a diagram illustrating an example disaggregated base station 181 architecture. The disaggregated base station 181 architecture may include one or more CUs 183 that may communicate directly with core network 190 via a backhaul link, or indirectly with the core network 190 through one or more disaggregated base station units (such as a Near-Real Time RIC 125 via an E2 link, or a Non-Real Time RIC 115 associated with a Service Management and Orchestration (SMO) Framework 105, or both). A CU 183 may communicate with one or more DUs 185 via respective midhaul links, such as an F1 interface. The DUs 185 may communicate with one or more RUs 187 via respective fronthaul links. The RUs 187 may communicate respectively with UEs 104 via one or more radio frequency (RF) access links. In some implementations, the UE 104 may be simultaneously served by multiple RUs 187.

Each of the units, i.e., the CUS 183, the DUs 185, the RUs 187, as well as the Near-RT RICs 125, the Non-RT RICs 115 and the SMO Framework 105, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, may be configured to communicate with one or more of the other units via the transmission medium. For example, the units may include a wired interface configured to receive or transmit signals over a wired transmission medium to one or more of the other units. Additionally, the units may include a wireless interface, which may include a receiver, a transmitter or transceiver (such as a radio frequency (RF) transceiver), configured to receive or transmit signals, or both, over a wireless transmission medium to one or more of the other units.

In some aspects, the CU 183 may host higher layer control functions. Such control functions may include radio resource control (RRC), packet data convergence protocol (PDCP), service data adaptation protocol (SDAP), or the like. Each control function may be implemented with an interface configured to communicate signals with other control functions hosted by the CU 183. The CU 183 may be configured to handle user plane functionality (i.e., Central Unit-User Plane (CU-UP)), control plane functionality (i.e., Central Unit-Control Plane (CU-CP)), or a combination thereof. In some implementations, the CU 183 may be logically split into one or more CU-UP units and one or more CU-CP units. The CU-UP unit may communicate bidirectionally with the CU-CP unit via an interface, such as the E1 interface when implemented in an O-RAN configuration. The CU 183 may be implemented to communicate with the DU 185, as necessary, for network control and signaling.

The DU 185 may correspond to a logical unit that includes one or more base station functions to control the operation of one or more RUs 187. In some aspects, the DU 185 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 185 may further host one or more low PHY layers. Each layer (or module) may be implemented with an interface configured to communicate signals with other layers (and modules) hosted by the DU 185, or with the control functions hosted by the CU 183.

Lower-layer functionality may be implemented by one or more RUs 187. In some deployments, an RU 187, controlled by a DU 185, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 187 may be implemented to handle over the air (OTA) communication with one or more UEs 104. In some implementations, real-time and non-real-time aspects of control and user plane communication with the RU(s) 187 may be controlled by the corresponding DU 185. In some scenarios, this configuration may enable the DU(s) 185 and the CU 183 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements, which may be managed via an operations and maintenance interface (such as an O1 interface). For virtualized network elements, the SMO Framework 105 may be configured to interact with a cloud computing platform (such as an open cloud (O-Cloud) 189) to perform network element life cycle management (such as to instantiate virtualized network elements) via a cloud computing platform interface (such as an O2 interface). Such virtualized network elements may include, but are not limited to, CUs 183, DUs 185, RUs 187 and Near-RT RICs 125. In some implementations, the SMO Framework 105 may communicate with a hardware aspect of a 4G RAN, such as an open eNB (O-eNB) 111, via an O1 interface. Additionally, in some implementations, the SMO Framework 105 may communicate directly with one or more RUs 187 via an O1 interface. The SMO Framework 105 also may include the Non-RT RIC 115 configured to support functionality of the SMO Framework 105.

The Non-RT RIC 115 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 183, one or more DUs 185, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

Referring to FIGS. 1A and 1B, in certain aspects, the UE 104 may include a SBFD behavior component 198 that is configured to monitor for downlink control information (DCI) including a slot format indication (SFI) for a set of sub-band full duplex (SBFD) symbols in a slot, the set of SBFD symbols respectively being associated with flexible resources in at least one flexible sub-band and uplink resources in an uplink (UL) sub-band, and the SFI being configured to indicate a downlink format, an uplink format, or a flexible format for one of: only the flexible resources associated with a SBFD symbol of the set of SBFD symbols, or the SBFD symbol including both the flexible resources and the uplink resources; and receive or transmit, or refrain from receiving or transmitting, data in the SBFD symbol according to at least one of a plurality of behaviors respectively based on a detected presence or a detected absence of the DCI. The UE may monitor for the DCI, and receive or transmit, or refrain from receiving or transmitting, data in the SBFD symbol, in communication with base station 102/180, disaggregated base station 181, a component of disaggregated base station 181 such as CU 183, DU 185, or RU 187, or some other network entity.

Although the present disclosure may focus on 5G NR, the concepts and various aspects described herein may be applicable to other similar areas, such as LTE, LTE-Advanced (LTE-A), Code Division Multiple Access (CDMA), Global System for Mobile communications (GSM), or other wireless/radio access technologies.

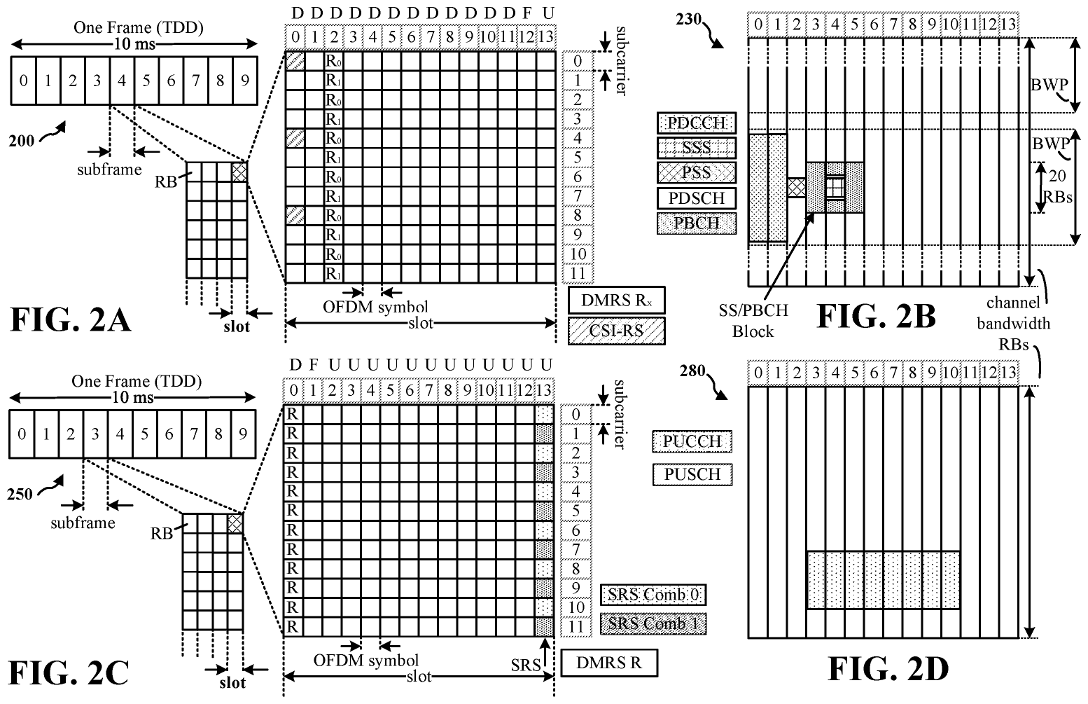

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency-division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies u 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology u, there are 14 symbols/slot and 2μ slots/subframe. The subcarrier spacing and symbol length/duration are a function of the numerology. The subcarrier spacing may be equal to 2\hat{ }μ*15 kilohertz (kHz), where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rx for one particular configuration, where 100× is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE may determine a physical cell identifier (PCI). Based on the PCI, the UE may determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data and may additionally be used to carry a buffer status report (BSR), a power headroom report (PHR), and/or UCI.

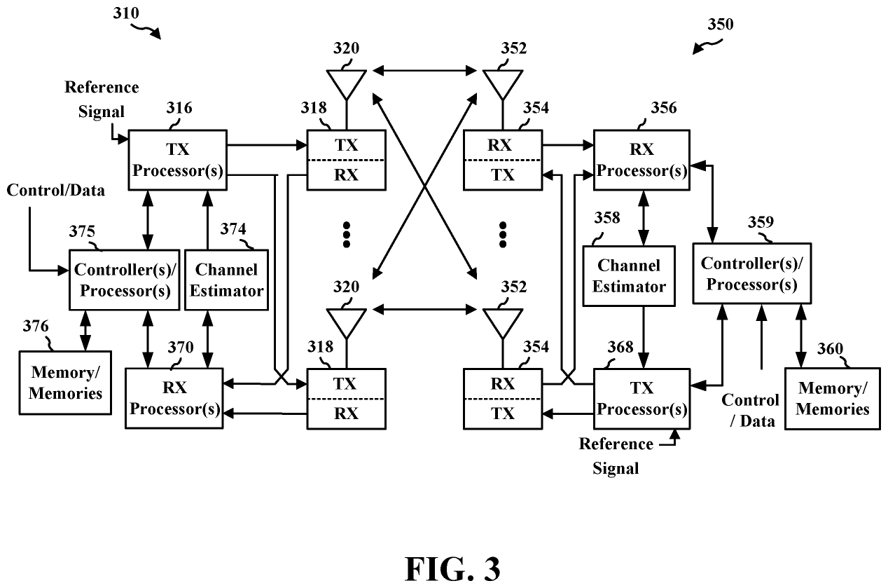

FIG. 3 is a block diagram of a base station 310 such as base station 102/180 in communication with a UE 350 such as UE 104 in an access network. IP packets from the EPC 160 may be provided to one or more controllers/processors 375 of base station 310. The one or more controllers/processors 375 implement layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The one or more controllers/processors 375 provide RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer protocol data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The one or more transmit (TX) processors 316 and the one or more receive (RX) processors 370 of base station 310 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The one or more TX processors 316 handle mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the one or more receive (RX) processors 356. The one or more TX processors 368 and the one or more RX processors 356 of UE 350 implement layer 1 functionality associated with various signal processing functions. The one or more RX processors 356 may perform spatial processing on the information to recover any spatial streams destined for the UE 350. If multiple spatial streams are destined for the UE 350, they may be combined by the one or more RX processors 356 into a single OFDM symbol stream. The one or more RX processors 356 then convert the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the one or more controllers/processors 359 of UE 350, which implement layer 3 and layer 2 functionality.

The one or more controllers/processors 359 may each be associated with one or more memories 360 that store program codes and data. The one or more memories 360, individually or in any combination, may be referred to as a computer-readable medium and may be any of the types of computer-readable mediums discussed herein (e.g., RAM, ROM, EEPROM, optical disk storage, magnetic disk storage, other magnetic storage devices, combinations of the aforementioned types of computer-readable media, or any other medium that can be used to store computer executable code in the form of instructions or data structures that can be accessed by a computer). The one or more controllers/processors 359 provide demultiplexing between transport and logical channels, packet reassembly, deciphering, header decompression, and control signal processing to recover IP packets from the EPC 160. The one or more controllers/processors 359 are also responsible for error detection using an ACK and/or NACK protocol to support HARQ operations.

Similar to the functionality described in connection with transmission by the base station 310, the one or more controllers/processors 359 of UE 350 provide RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the one or more TX processors 368 to select the appropriate coding and modulation schemes, and to facilitate spatial processing. The spatial streams generated by the one or more TX processors 368 may be provided to different antenna 352 via separate transmitters 354TX. Each transmitter 354TX may modulate an RF carrier with a respective spatial stream for transmission.

The transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to one or more RX processors 370.

The one or more controllers/processors 375 may each be associated with one or more memories 376 that store program codes and data. The one or more memories 376, individually or in any combination, may be referred to as a computer-readable medium and may be any of the types of computer-readable mediums discussed herein (e.g., RAM, ROM, EEPROM, optical disk storage, magnetic disk storage, other magnetic storage devices, combinations of the aforementioned types of computer-readable media, or any other medium that can be used to store computer executable code in the form of instructions or data structures that can be accessed by a computer). The one or more controllers/processors 375 provide demultiplexing between transport and logical channels, packet reassembly, deciphering, header decompression, control signal processing to recover IP packets from the UE 350. IP packets from the one or more controllers/processors 375 may be provided to the EPC 160. The one or more controllers/processors 375 are also responsible for error detection using an ACK and/or NACK protocol to support HARQ operations.

At least one of the one or more TX processors 368, the one or more RX processors 356, and the one or more controllers/processors 359, may be configured to perform aspects in connection with SBFD behavior component 198 of FIG. 1A.

DCI format 2_0 includes a Slot Format Indicator (SFI) that specifies the slot format for certain symbols or slots that have been classified as flexible by a Time Division Duplex (TDD) downlink/uplink configuration (such as tdd-UL-DL-ConfigurationCommon or tdd-ULDL-ConfigurationDedicated). These flexible symbols may be redefined as either downlink or uplink, or they may be maintained in their flexible state. The behavior of UE 104 is dependent on these configurations. For example, in a downlink TDD configuration, the UE 104 is configured to receive data, whereas in an uplink TDD configuration, the UE 104 is configured to transmit data. However, when the TDD configuration indicates the symbols remain flexible, the UE 104 follows certain specific behaviors depending on the SFI.

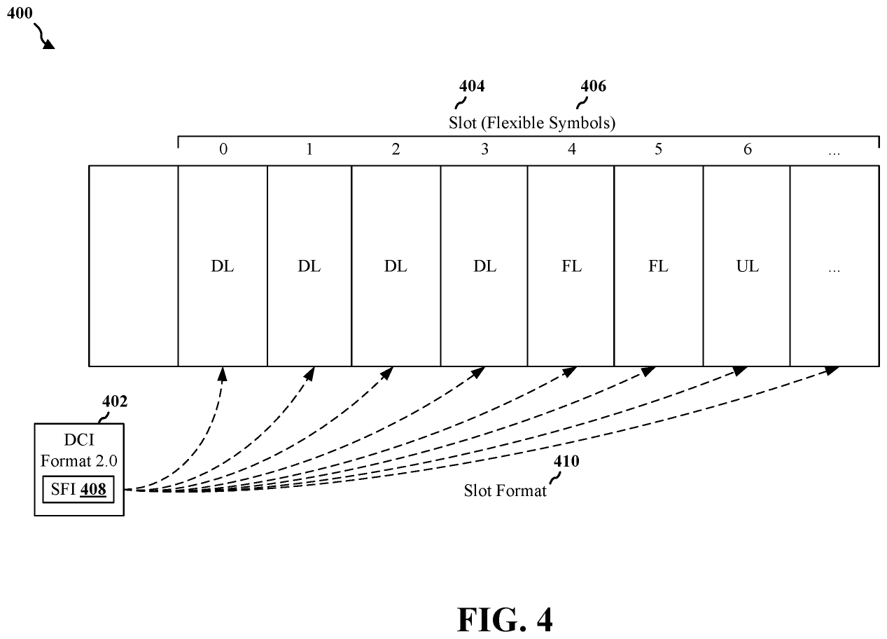

FIG. 4 presents an example 400 of a DCI having DCI format 2_0 402. This format is employed to modify or specify certain flexible symbols, flexible slots such as slot 404, or a combination of flexible symbols and slots, as having downlink, uplink, or flexible symbols. If a group of symbols 406 within a slot is designated as downlink or uplink by either tdd-UL-DL-ConfigurationCommon or tdd-UL-DL-ConfigurationDedicated, the UE 104 does not expect to detect DCI format 2_0 402 with an SFI 408 or an SFI-index field value that signifies the group of symbols 406 of the slot as uplink or downlink, respectively, or as flexible. Otherwise, if the TDD configuration designates the group of symbols 406 within a slot as flexible, such as illustrated in FIG. 4, the UE 104 is configured to monitor the DCI format 2-0 402, identify the DCI and determine a slot format 410 for these flexible symbols 406. For instance, in the example of FIG. 4, the SFI 408 may indicate symbol 0 is downlink (DL), symbol 1 is DL, symbol 2 is DL, symbol 3 is DL, symbol 4 is flexible (FL), symbol 5 is FL, symbol 6 is uplink (UL), and so forth. Alternatively, the SFI 408 may indicate a different slot format for slot 404 in other examples.

The UE 104 may exhibit specific behaviors when it identifies the DCI format 2_0 402 and the SFI 408 designates that the flexible symbols 406 align with a certain slot format such as slot format 410. More specifically, if a group of symbols within a slot, such as symbols 406, is communicated to the UE 104 as flexible by tdd-UL-DL-ConfigurationCommon and tdd-UL-DL-ConfigurationDedicated (if provided), or when these TDD configurations are not supplied to the UE, and if the UE 104 identifies a DCI format 2_0 that establishes a format for the slot using a slot format value other than 255, such as slot format 410, then the UE 104 may adopt one of several behaviors based on varying scenarios.

Firstly, when only the SFI 408 designates DL symbols, the UE 104 monitors the PDCCH candidates. More particularly, if one or more symbols from the set are included in a CORESET configured for PDCCH monitoring, the UE receives PDCCH in the CORESET only if the SFI-index field value in DCI format 2_0 specifies that these symbols are downlink symbols. Thus, the UE may receive PDCCH for example in DL symbols 0-3 in FIG. 4.

Secondly, when the SFI 408 designates FL symbols, the UE 104 receives the PDSCH and CSI triggered by DL DCI. More particularly, if the SFI-index field value in DCI format 2_0 signifies the group of symbols of the slot as flexible and the UE identifies a DCI format indicating to receive PDSCH or CSI-RS in the group of symbols of the slot, the UE receives PDSCH or CSI-RS in the group of symbols of the slot. Thus, the UE may receive PDSCH or CSI-RS scheduled by a downlink grant for example in FL symbols 4 and 5 in FIG. 4.

Thirdly, when the SFI 408 designates FL symbols, the UE 104 transmits the SRS, PUCCH, PRACH, and PUSCH as directed by UL-DCI or a random access response (RAR)-grant. More particularly, if the SFI-index field value in DCI format 2_0 signifies the group of symbols of the slot as flexible and the UE identifies a DCI format, a RAR UL grant, fallback RAR UL grant, or success RAR indicating to transmit PUSCH, PUCCH, PRACH, or SRS in the group of symbols of the slot, the UE transmits the PUSCH, PUCCH, PRACH, or SRS in the group of symbols of the slot. Thus, the UE may transmit SRS, PUCCH, PRACH or PUSCH scheduled by an uplink grant for example in FL symbols 4 and 5 in FIG. 4.

Fourthly, when the SFI 408 designates FL symbols, and the UE 104 does not identify a DCI format indicating to receive PDSCH or CSI-RS, or the UE does not identify a DCI format, a RAR UL grant, fallback RAR UL grant, or success RAR indicating to transmit PUSCH, PUCCH, PRACH, or SRS in the group of symbols of the slot, the UE refrains from transmitting or receiving in the group of symbols of the slot. Thus, the UE may not receive PDSCH or CSI-RS periodically or semi-persistently scheduled by an RRC configuration (i.e., configured by RRC or higher layers), nor transmit PUSCH, PUCCH, PRACH, or SRS periodically or semi-persistently scheduled by an RRC configuration (i.e., configured by RRC or higher layers), for example in FL symbols 4 and 5 in FIG. 4.

Fifthly, only when the SFI 408 designates DL symbols, the UE 104 receives PDSCH and CSI configured by higher-layer. More particularly, if the UE is configured by higher layers to receive PDSCH or CSI-RS in the group of symbols of the slot, the UE receives the PDSCH or the CSI-RS in the group of symbols of the slot only if an SFI-index field value in DCI format 2_0 signifies the group of symbols of the slot as downlink and, if applicable, the group of symbols is within the remaining channel occupancy duration. Thus, the UE may receive PDSCH and CSI configured by RRC in DL symbols 0-3 of FIG. 4.

Sixthly, irrespective of whether the SFI 408 designates DL or FL, the UE 104 receives a downlink positioning reference signal (DL-PRS). More particularly, if the UE is configured by higher layers to receive DL PRS in the group of symbols of the slot, the UE receives the DL PRS in the group of symbols of the slot only if an SFI-index field value in DCI format 2_0 signifies the group of symbols of the slot as downlink or flexible. Thus, the UE may receive DL PRS in DL/FL symbols 0-5 of FIG. 4.

Seventhly, only when the SFI 408 designates UL, the UE 104 transmits PUCCH, PRACH, and PUSCH as configured by the higher layer. More particularly, if the UE is configured by higher layers to transmit PUCCH, PUSCH, or PRACH in the group of symbols of the slot, the UE transmits the PUCCH, PUSCH, or PRACH in the slot only if an SFI-index field value in DCI format 2_0 signifies the group of symbols of the slot as uplink. Thus, the UE may transmit PUCCH, PRACH, and PUSCH configured by RRC in UL symbol 6 of FIG. 4.

Finally, only when the SFI 408 designates UL, the UE transmits SRS as configured by the higher layer. If the UE is configured by higher layers to transmit SRS in the group of symbols of the slot, the UE transmits the SRS only in a subset of symbols from the group of symbols of the slot indicated as uplink symbols by an SFI-index field value in DCI format 2_0. Thus, the UE may transmit SRS configured by RRC in UL symbol 6 of FIG. 4.

The UE 104 may also identify various error scenarios in relation to the aforementioned behaviors. Firstly, there is an error scenario between SFI 408 indicating DL and UL-DCI (uplink grant) or RAR-grant. More particularly, the UE does not anticipate detecting an SFI-index field value in DCI format 2_0 indicating the group of symbols of the slot as downlink and also identifying a DCI format, a RAR UL grant, fallback RAR UL grant, or success RAR instructing the UE to transmit SRS, PUSCH, PUCCH, or PRACH, in one or more symbols from the group of symbols of the slot. Thus, the UE does not expect to receive an uplink grant to transmit SRS, PUSCH, PUCCH, or PRACH for example in DL symbols 0-3 of FIG. 4.

Secondly, there is an error scenario between SFI 408 indicating symbols DL/FL and PUSCH repetition by Type-2 grant. More particularly, the UE 104 does not anticipate detecting an SFI-index field value in DCI format 2_0 indicating the group of symbols of the slot as downlink or flexible if the group of symbols of the slot includes symbols corresponding to any repetition of a PUSCH transmission activated by an UL Type 2 grant PDCCH. Thus, the UE does not expect to transmit a PUSCH repetition, activated by a configured Type-2 uplink grant, for example in DL/FL symbols 0-5 of FIG. 4.

Thirdly, there is an error scenario between SFI 408 indicating symbols UL and UE receiving DL-DCI. More particularly, the UE 104 does not anticipate detecting an SFI-index field value in DCI format 2_0 indicating the group of symbols of the slot as uplink and also identifying a DCI format instructing the UE to receive PDSCH or CSI-RS in one or more symbols from the group of symbols of the slot. Thus, the UE does not expect to receive a PDSCH or CSI-RS, scheduled by a downlink grant, for example in UL symbol 6 of FIG. 4.

Furthermore, the UE 104 may execute downlink collision handling based on different scenarios involving the SFI 408 and DCI when the UE detects DCI format 2_0 402. Firstly, the UE may manage collisions between DL configured by higher-layer and DG-uplink (uplink grants) in SFI-FL/SFI-UL symbols. More particularly, if the UE is configured by higher layers to receive a CSI-RS or a PDSCH in a group of symbols of a slot and the UE identifies a DCI format 2_0 with a slot format value other than 255 that indicates a slot format with a subset of symbols from the group of symbols as uplink or flexible, or the UE identifies a DCI format indicating to transmit PUSCH, PUCCH, SRS, or PRACH in at least one symbol in the group of the symbols, the UE cancels the CSI-RS reception in the group of symbols of the slot or cancels the PDSCH reception in the slot. Thus, the UE may refrain from receiving PDSCH or CSI-RS, configured by RRC, for example in FL/UL symbols 4-6 of FIG. 4 in response to receiving an uplink grant to transmit PUSCH, PUCCH, SRS, or PRACH in slot 404.

Secondly, DL configured by higher layer (DL-PRS) in SFI-UL is cancelled to transmit DG uplink (SRS, PUCCH, PUSCH, PRACH). More particularly, if a UE is configured by higher layers to receive a DL PRS in a group of symbols of a slot and the UE identifies a DCI format 2_0 with a slot format value other than 255 that indicates a slot format with a subset of symbols from the group of symbols as uplink, or the UE identifies a DCI format indicating to the UE to transmit PUSCH, PUCCH, SRS, or PRACH in at least one symbol in the group of the symbols, the UE cancels the DL PRS reception in the group of symbols of the slot. Thus, the UE may refrain from receiving DL-PRS, configured by RRC, for example in UL symbol 6 of FIG. 4 in response to receiving an uplink grant to transmit SRS, PUCCH, PUSCH, or PRACH in slot 404.

Thirdly, the UE considers FL as DL and receives PDCCH if SFI value is not UL/FL and UE does not receive UL DCI format. More particularly, the UE assumes that flexible symbols in a CORESET configured to the UE for PDCCH monitoring are downlink symbols if the UE does not identify an SFI-index field value in DCI format 2_0 indicating the group of symbols of the slot as flexible or uplink and the UE does not identify a DCI format indicating to the UE to transmit SRS, PUSCH, PUCCH, or PRACH in the group of symbols. Thus, the UE may receive PDCCH for example in DL symbol 0-3 of FIG. 4 in the absence of receiving an uplink grant scheduling SRS, PUSCH, PUCCH, or PRACH in slot 404.

Consequently, the UE 104 may execute one of several behaviors, identify various error scenarios, and perform downlink collision handling, based on different scenarios involving the SFI 408 and DCI when the UE detects DCI format 2_0 402. For example, the UE may receive the PDCCH in a monitoring occasion or receive the PDSCH or CSI-RS. This downlink data could be based on a periodic or semi-static persistent configuration. For downlink data receptions configured by RRC and for PDCCH candidates configured by RRC, when the flexible symbols 406 are indicated to remain flexible in SFI 408, they are reserved. Thus, the UE disregards any data that is configured by RRC in these symbols and will only perform uplink or downlink communication as directed by DCI in these symbols. The UE may receive PDCCH or downlink PDSCH or CSI-RS triggered by downlink DCI in these symbols. The UE may transmit uplink, whether SRS or PUCCH or PRACH or PUSCH, if this uplink data is triggered by DCI or uplink grant. If the UE does not receive any DCI, it remains idle rather than perform RRC-configured uplink transmissions. Regardless of whether the symbols are indicated as flexible, the UE receives PRS due to its higher priority relative to other downlink data. If the UE receives a DCI and it indicates uplink data is scheduled, the UE will transmit in the uplink symbols. This transmission may be a PUSCH, PRACH, or SRS for example. If the SFI 408 indicates the symbols are downlink and the UE receives uplink DCI, or vice versa, it may be considered an error. Similarly, if the SFI 408 indicates downlink or flexible symbols and the UE has a Type 2 grant for transmission, it may also be considered an error. In the event of downlink collisions, if the UE receives a SFI that designates some symbols as flexible or uplink, and downlink data is already configured by RRC, a conflict may arise. This conflict may be resolved by giving higher priority to the data indicated by the DCI, and thus the downlink transmission may be cancelled and the UE may transmit the uplink data. In a scenario where a downlink PRS is configured and the UE receives an uplink grant, the PRS may be cancelled. If the UE does not receive any uplink DCI, the flexible symbols may be considered as downlink. If a PDCCH is configured in a CORESET, and the UE receives these flexible symbols, the downlink symbols may be preserved for the UE to receive the downlink PDCCH, so long as the UE did not detect any uplink DCI.

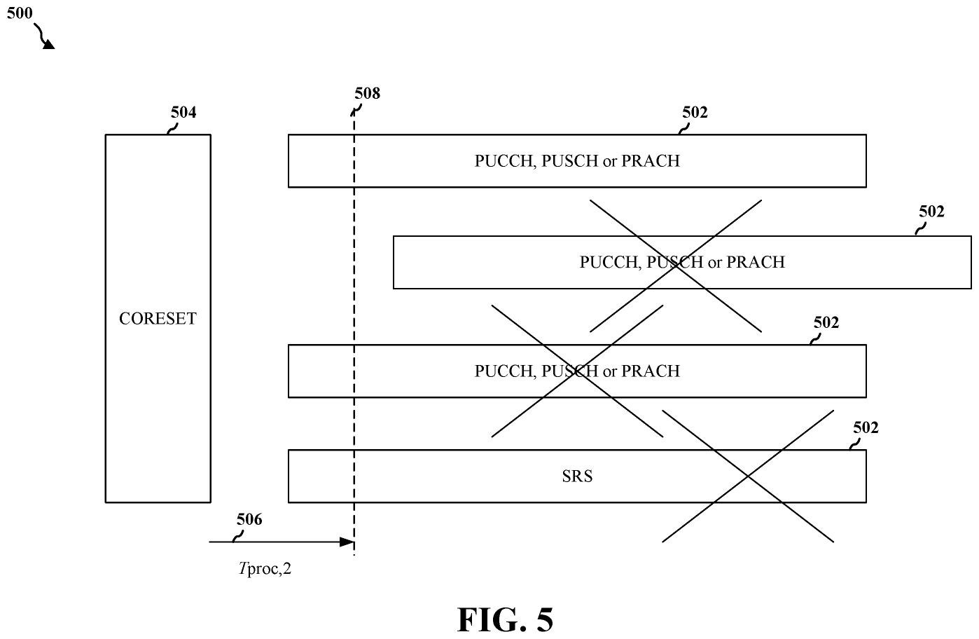

FIG. 5 illustrates an example 500 of a scenario where the UE 104 may execute uplink collision handling between UL configured by higher-layer and DG-downlink in SFI-FL/DL symbols. More particularly, if a UE is configured by higher layers to transmit SRS, PUCCH, PUSCH, or PRACH in a group of symbols of a slot and the UE identifies a DCI format 2_0 with a slot format value other than 255 that indicates a slot format with a subset of symbols from the group of symbols as downlink or flexible, or the UE identifies a DCI format indicating to the UE to receive CSI-RS or PDSCH in a subset of symbols from the group of symbols, then the UE may perform one of the following behaviors. These behaviors relate to the sending or cancellation of uplink transmissions 502 in flexible symbols 406 of slot 404 for PUSCH or PUCCH or PRACH or SRS depending on their timing with respect to a PDCCH in a CORESET 504 and a PUSCH preparation time T_{proc,2} 506.

Firstly, if the UE 104 does not indicate a capability of partial cancellation, the UE does not anticipate cancelling the transmission 502 of the PUCCH, PUSCH, or PRACH in the group of symbols 406 if the first symbol in the group occurs within T_{proc,2} 506 relative to a last symbol of a PDCCH reception where the UE identifies the DCI format. Otherwise, the UE cancels the PUCCH, PUSCH, or an actual repetition of the PUSCH, or the PRACH transmission in the group of symbols. Secondly, if the UE indicates the capability of partial cancellation, the UE does not anticipate cancelling the transmission 502 of the PUCCH, PUSCH, or PRACH in symbols from the group of symbols 406 that occur within T_{proc,2} 502 relative to a last symbol of a PDCCH reception where the UE identifies the DCI format. The UE cancels the PUCCH, PUSCH, or an actual repetition of the PUSCH, or the PRACH transmission in remaining symbols from the group of symbols. Thirdly, the UE does not anticipate cancelling the transmission of SRS in symbols from the subset of symbols that occur within T_{proc,2} 506 relative to a last symbol of a PDCCH reception where the UE identifies the DCI format. The UE cancels the SRS transmission in remaining symbols from the subset of symbols. In each of these behaviors, T_{proc,2} 506 is the PUSCH preparation time for the corresponding UE processing capability assuming d_{2,1}=1 and u corresponds to the smallest SCS configuration between the SCS configuration of the PDCCH carrying the DCI format and the SCS configuration of the SRS, PUCCH, PUSCH or μᵣ, where μᵣ corresponds to the SCS configuration of the PRACH if it is 15 kHz or higher; otherwise μᵣ=0.

Thus, in the example of FIG. 5, if a collision occurs between uplink data transmissions 502 configured by RRC and a DCI received in CORESET 504 that schedules to transmit this uplink data, then cancellation of the uplink data transmissions is based on a timeline 508 based on T_{proc,2} 506 and a time when the transmission is scheduled to occur relative to this timeline 508. In particular, if the transmission 502 is scheduled to take place after this timeline 508, the UE will cancel it. However, if the transmission 502 started earlier, the transmission 502 is not cancelled unless the UE supports a capability referred to as partial cancellation. An example without partial cancellation is illustrated by the top two transmissions in FIG. 5, where one transmission is scheduled to take place before timeline 508 and is thus not cancelled, while the other transmission is scheduled to take place after timeline 508 and is thus cancelled in its entirety. Alternatively, if the UE supports partial cancellation, it will initiate the transmission 502 and then cancel the rest after the timeline 508. This is illustrated by the third transmission in FIG. 5, where the portion of the PUCCH, PUSCH, or PRACH before timeline 508 is not cancelled but the portion afterwards is canceled. In the case of SRS, any transmission 502 scheduled after this timeline 508 is cancelled, while the portion scheduled prior to timeline 508 remains. This is illustrated by the last transmission in FIG. 5 of SRS.

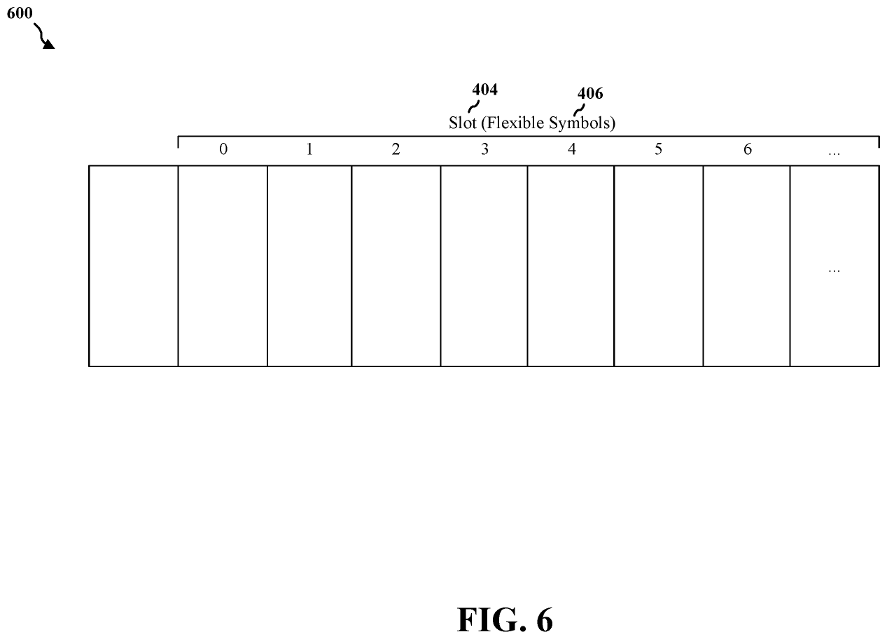

FIG. 6 illustrates an example 600 of other scenarios where the UE 104 is configured to detect the DCI format 2_0 402, but here does not detect it (the DCI is not sent or the UE fails to decode the DCI), and thus the UE may exhibit different behaviors in slot 404 including symbols 406 than those described with respect to FIGS. 4 and 5. More specifically, for a group of symbols of a slot that are indicated as flexible by tdd-UL-DL-ConfigurationCommon, and tdd-UL-DL-ConfigurationDedicated if provided, or when tdd-UL-DL-ConfigurationCommon, and tdd-UL-DL-ConfigurationDedicated are not provided to the UE, and if the UE does not detect DCI format 2_0 402 providing slot format 410 for the slot, then the UE may perform one of the following behaviors. Firstly, the UE receives PDSCH or CSI-RS in the group of symbols 406 of the slot 404 if the UE receives a corresponding indication by a DCI format. Secondly, the UE transmits SRS, PUCCH, PUSCH, or PRACH in the group of symbols 406 of the slot 404 if the UE receives a corresponding indication by a DCI format, a RAR UL grant, fallback RAR UL grant, or success RAR. Thirdly, the UE receives PDCCH. Fourthly, if the UE is configured by higher layers to receive PDSCH in the group of symbols 406 of the slot 404, the UE does not receive the PDSCH in the group of symbols of the slot. Fifthly, if the UE is configured by higher layers to receive CSI-RS in the group of symbols 406 of the slot 404, the UE does not receive the CSI-RS in the group of symbols of the slot, except when UE is provided a configuration of a channel occupancy (CO) duration per cell (CO-DurationsPerCell) and the group of symbols 406 of the slot 404 are within the remaining channel occupancy duration. Finally, if the UE is configured by higher layers to receive DL PRS in the group of symbols 406 of the slot 404, the UE receives the DL PRS.

Similarly, with respect to collision handling when the UE 104 does not detect DCI format 2_0 402, the UE may cancel downlink and uplink transmissions configured by higher layers based on an enable configured uplink configuration (enableConfiguredUL). Firstly, if the UE is configured by higher layers to transmit SRS, PUCCH, PUSCH, or PRACH in the group of symbols 406 of the slot 404 and the UE is provided enableConfiguredUL, the UE can transmit the SRS, PUCCH, PUSCH, or PRACH, respectively. Thus, the UE may perform cancellation of DL reception (PDSCH, CSI-RS) configured by higher layers. Secondly, if the UE is configured by higher layers to transmit SRS, PUCCH, PUSCH, or PRACH in the group of symbols 406 of a slot 404 and the UE is not provided enableConfiguredUL, then cancellation of UL configured by higher-layer follows the cancellation timeline (T_{proc,2}) and UE partial-cancellation capability such as described with respect to FIG. 5. More specifically, if the UE does not indicate the capability of partial cancellation, the UE does not anticipate to cancel the transmission 502 of the PUCCH, PUSCH, or an actual repetition of the PUSCH, or the PRACH in the slot if the first symbol of the PUCCH, PUSCH, actual repetition of the PUSCH, or the PRACH in the slot occurs within T_{proc,2} 506 relative to a last symbol of a PDCCH reception where the UE is configured to monitor PDCCH for DCI format 2_0; otherwise, the UE cancels the PUCCH, PUSCH, actual repetition of the PUSCH, or the PRACH in the slot. Alternatively, if the UE indicates the capability of partial cancellation, the UE does not anticipate cancelling the transmission of the PUCCH, PUSCH, actual repetition of the PUSCH, or the PRACH in symbols from the group of symbols 406 that occur within T_{proc,2} 506 relative to a last symbol of a PDCCH reception where the UE is configured to monitor PDCCH for DCI format 2_0. The UE cancels the PUCCH, PUSCH, actual repetition of the PUSCH, or the PRACH transmission in remaining symbols from the group of symbols. Additionally, the UE does not anticipate cancelling the transmission 502 of SRS in symbols from the group of symbols 406 that occur within T_{proc,2} 506 relative to a last symbol of a PDCCH reception where the UE is configured to monitor PDCCH for DCI format 2_0. The UE cancels the SRS transmission in remaining symbols from the group of symbols. Here, T_{proc,2} 506 is the PUSCH preparation time for the corresponding UE processing capability assuming d_{2,1}=1 and u corresponds to the smallest SCS configuration between the SCS configuration of the PDCCH carrying the DCI format and the SCS configuration of the SRS, PUCCH, PUSCH or μᵣ, where μᵣ corresponds to the SCS configuration of the PRACH if it is 15 kHz or higher; otherwise μᵣ=0.

Thus, the example 600 of FIG. 6 illustrates a scenario affecting the behavior of UE 104 when it is configured to, but does not detect, the DCI format 2_0 402. If the UE does not detect the DCI, it may consider the resources in symbols 406 as reserved. This means the UE may only receive downlink communication which is triggered by DCI, and will only transmit data in the uplink also triggered by DCI. Any configurations set by RRC, such as a PDSCH or CSI-RS by higher layers, will not be received by the UE, with the exception of the PRS due to its higher priority. Thus, a communication to be transmitted or received that is directed by DCI may proceed at the UE, but a communication directed by RRC may be disregarded. The UE may cancel uplink transmissions if they fall within the cancellation timeline 508. If the transmission 502 falls outside the timeline 508, the UE may perform partial cancellation depending on its capabilities. If there are any configurations set by the RRC, the UE may disregard them after the timeline 508. For signals such as the PUSCH, PUCCH, PRACH, and SRS, any symbols up to the PUSCH preparation time (T_{proc,2} 506) may be transmitted, and any symbols after T_{proc,2} may be dropped.

While the aforementioned UE behaviors are well defined for TDD symbols, there are still questions regarding how these behaviors apply to sub-band full duplex (SBFD) flexible symbols (SBFD symbols) for SBFD-aware UEs. SBFD is a technology that enables simultaneous transmission and reception of signals in different sub-bands of a same frequency band, significantly enhancing the efficiency of wireless communication systems. SBFD-aware UEs refer to UEs that are aware, through signaling, that the network is operating in a SBFD mode. This awareness may be achieved either through direct signaling or through broadcast signaling that informs the UE about the time and frequency resources of the uplink and downlink bandwidth when the network is operating in a SBFD mode. In this context, a SBFD-aware UE is still operating in a half-duplex mode, indicating it may only transmit or receive at any given time, not both simultaneously. Thus, a SBFD-aware UE indicates the UE is in half-duplex mode but is aware that the network is operating in full duplex mode across different sub-bands of the channel. This may be because the UE is not configured for full duplex operation, or the UE selects not to operate in full duplex mode.

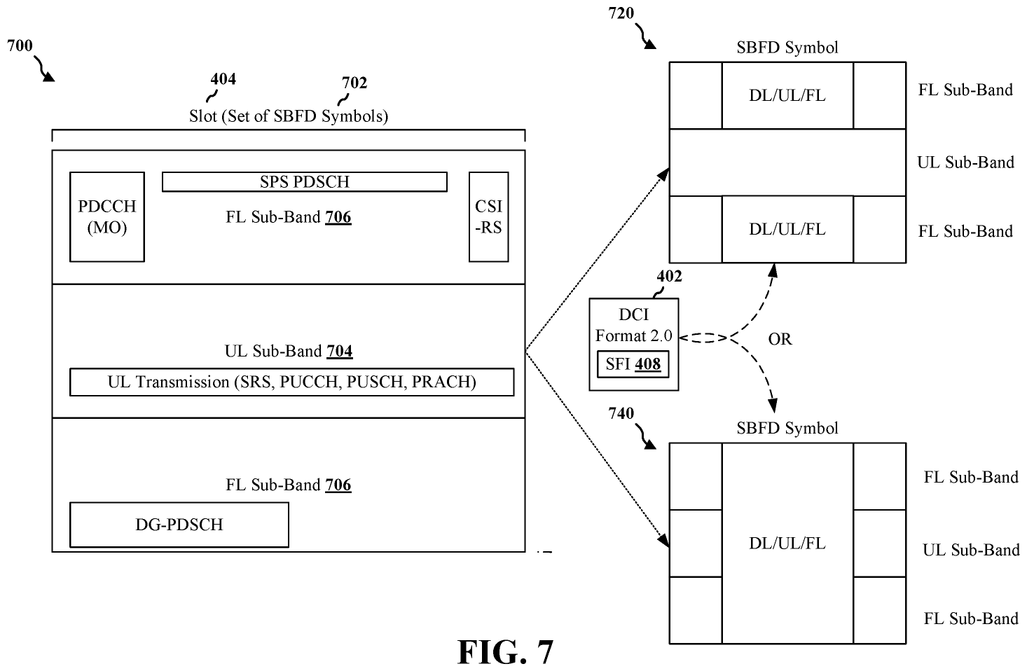

FIG. 7 illustrates an example 700 depicting the flexible symbols 406 in slot 404 after they are converted to SBFD symbols 702 and how this conversion interacts with the SFI 408. Here, similar to FIG. 4, flexible symbols 406 are indicated to the UE by either a common or dedicated TDD pattern. If the TDD configuration indicates the symbols are not downlink nor uplink, then the symbols are flexible. If there is no TDD pattern indicated to the UE, these symbols are assumed to be flexible by default. However, in the scenario depicted in FIG. 7, the network also informs the UE that these symbols have been converted to SBFD symbols 702, and that there is an uplink band within these resources. For instance, the UE 104 may receive two configurations from base station 102 together indicating SBFD symbols 702: one configuration for the time domain including the TDD pattern, and another configuration for the frequency domain including the resources, such as RBs, or sub-bands. When the UE receives this dedicated frequency configuration, the UE may ascertain that the flexible symbols 406 have become SBFD symbols 702, where some of the resources are in an uplink sub-band 704 or a guard band, while the rest of the resources remain in one or more flexible sub-bands 706.

However, a challenge arises when a SBFD-aware UE is configured to monitor the DCI format 2_0 402 for SFI 408 and either detects it, such as in the example of FIG. 4, or does not detect it, such as in the example of FIG. 6, but the SFI 408 applies to SBFD symbols 702. As previously described, SFI 408 may be indicated in a group common signaling such as DCI format 2_0 402, which may designate some of the flexible symbols 406 to be used for downlink or uplink or leave them as flexible. Yet, if the UE 104 detects the SFI 408 and it indicates SBFD symbols 702 as flexible, uplink, or downlink, and some of those symbols have some configuration or scheduling of a downlink or uplink signal by RRC or by DCI, then there is a question of what the UE behavior will be for the data configured or scheduled in those SBFD symbols 702. More specifically, in such scenarios, there is no specification regarding the UE behavior in SBFD symbols for receiving PDCCH in the slot, receiving the PDSCH or CSI-RS configured by higher layer or dynamically by DL DCI, and transmitting SRS, PUCCH, PUSCH or PRACH configured by higher-layer or dynamically by UL DCI. Therefore, it would be helpful to provide the UE behavior in such scenarios.

The behavior of UE 104 when it detects the DCI format 2_0 402, and when it does not, may be subject to two interpretations of the SFI indication in SBFD flexible symbols 702. These two interpretations based on SFI 408 are depicted respectively in SBFD symbols 720, 740 in the example 700 of FIG. 7. In a first interpretation, as illustrated in SBFD symbol 720, the SFI indication is applied only to the flexible resources outside the uplink sub-band 704. Thus, the SFI indication only affects the flexible sub-band(s) 706 (FL-SB). In a second interpretation, as illustrated in SBFD symbol 740, the symbols are no longer considered as SBFD but are converted to TDD symbols. These symbols could be TDD downlink, TDD uplink, or TDD flexible symbols based on the actual indication of the SFI 408. In this case, the SFI indication applies to all frequency resources of the SBFD symbol including the flexible sub-band(s) 706 and the uplink sub-band (UL-SB), effectively flipping the SBFD symbol to a TDD symbol.

Aspects of the present disclosure provide several UE behaviors responsive to the UE 104 detecting or failing to detect the DCI format 2_0 402 including SFI 408 for SBFD symbols 702. If the UE 104 has detected the DCI, there are multiple cases to consider, depending on whether the DCI indicates the symbols 702 as flexible, downlink, or uplink. Multiple sets of behaviors depending on SFI 408 are provided, each based on a different interpretation of the symbols 720, 740. The first set of behaviors correspond to the first interpretation above, where the flexible resources are flipped to downlink or uplink or remain flexible, but there is still an uplink sub-band, as illustrated in SBFD symbol 720. Thus, the symbol is still a SBFD symbol, but the direction of only the flexible sub-band 706 has been indicated in the SFI 408. The second set of behaviors correspond to the second interpretation above, where the symbol is no longer an SBFD symbol but is converted back to a TDD symbol, as illustrated in SBFD symbol 740. For example, the symbol may be changed from SBFD to a TDD downlink, uplink, or flexible symbol, depending on the SFI indication. In a third scenario, the UE 104 is configured to monitor the DCI format 2_0 402, but it does not detect this DCI similar to the example of FIG. 6. In this case, it is important to define what the behavior of the UE would be for SBFD symbols 702. The various aspects of the present disclosure address these different scenarios and provide clear guidelines for UE behavior in each case.

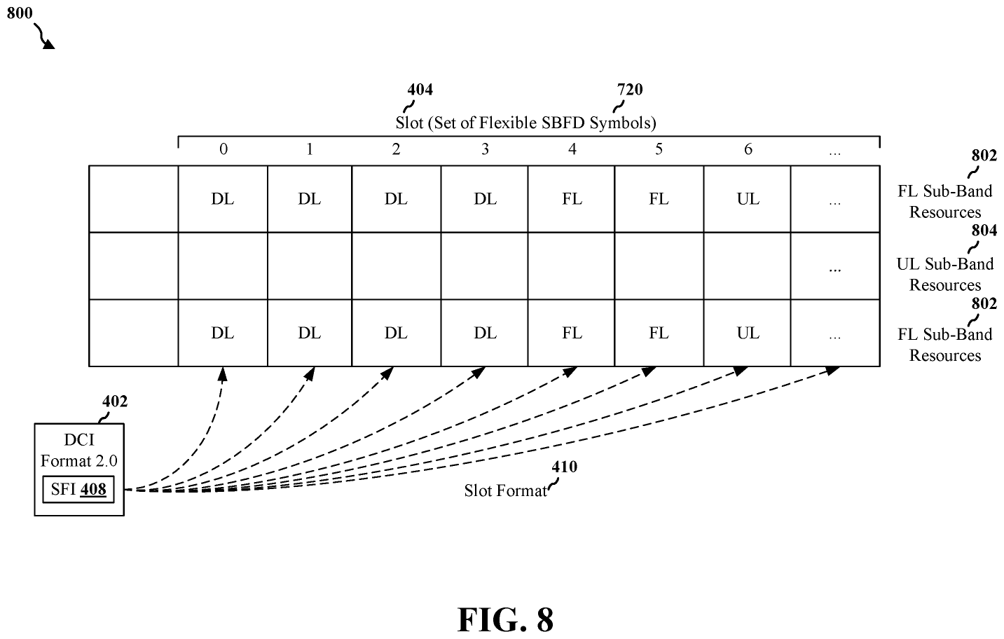

FIG. 8 presents an example 800 of a scenario where the UE 104 is configured with a set of sub-bands 704, 706 including FL resources 802 and UL resources 804 in SBFD symbols 720. The sub-bands 706 are indicated to the UE as flexible, and uplink sub-band 704 is configured between the flexible sub-bands 706 in this example. The UE 104 then receives SFI 408 which indicates a slot format combination, or more generally slot format 410, applicable only to the flexible sub-bands 706 or FL resources 802 within the SBFD symbols 720. Here, different UE behaviors are provided depending on the SFI 408 when the UE detects DCI format 2_0 402 in SBFD flexible symbols 720. More specifically, for a set of sub-band(s) 706 or resources 802 in SBFD symbols 720 of slot 404 indicated to a UE as flexible by tdd-UL-DL-ConfigurationCommon and tdd-UL-DLConfigurationDedicated if provided, or when tdd-UL-DL-ConfigurationCommon and tdd-UL-DLConfigurationDedicated are not provided to the UE, and configured with UL sub-band 704, and if the UE detects DCI format 2_0 402 providing the format 410 for the slot using a slot format value other than 255, the UE 104 may perform one of various sets of behaviors depending on the SFI 408. These different cases will now be described.

In a first case, several behaviors are provided of the UE 104 when it detects the SFI 408 in SBFD flexible symbols 720, specifically when the SFI-index field value in DCI format 2_0 402 indicates the set of sub-band(s) 706 or resources 802 in SBFD symbols 720 of the slot 404 as flexible. Thus, in the example of FIG. 8, these behaviors may apply to FL symbols 4 and 5 of slot 404. Firstly, the UE receives PDSCH and CSI-RS triggered by DL DCI in the one or more flexible resources 802 or sub-band(s) 706. Secondly, the UE does not receive PDSCH and CSI configured by higher-layer in the flexible resources 802 or sub-band(s) 706. Thirdly, the UE does not monitor the PDCCH candidate, and thus the UE does not receive the PDCCH. Fourthly, the UE receives the DL-PRS in the flexible sub-band(s) 706. Fifthly, the UE transmits SRS, PUCCH, PUSCH or PRACH in the uplink sub-band 704 or flexible sub-band 706 triggered by UL-DCI. Sixthly, the UE does not transmit SRS, PUCCH, PUSCH or PRACH configured by higher layer in the flexible sub-band 706. Finally, the UE transmits SRS, PUCCH, PUSCH or PRACH configured by higher layer in the uplink sub-band 704 unless UE detects DL-DCI scheduling PDSCH or CSI-RS. In this case, the UE follows the uplink cancellation timeline based on UE partial-cancellation capability such as described with respect to FIG. 5.

Thus, this flexible indication in SFI 408 indicates that the UE may only receive in the flexible sub-bands 706 if the data is scheduled by DCI. The UE may not receive data scheduled by RRC in the flexible sub-bands 706 and may not monitor the PDCCH in the flexible sub-bands 706. However, the UE may still receive the PRS due to its higher priority. Regarding transmission, if the transmission is either in the uplink sub-band 704 or the flexible sub-bands 706 and the transmission is triggered by DCI, the transmission may be allowed. If a transmission by RRC is in the flexible sub-band 706, it may be dropped, while if a transmission by RRC is in the uplink sub-band 704, it may still be allowed. Thus, for uplink sub-band 704, whether configured by RRC or by DCI, this uplink data may still be transmitted. If there is any type of cancellation, they will follow the timeline 508 of the cancellation, which is T_{proc,2} 506. If the UE supports partial cancellation, it may be applied.

In a second case, different UE behaviors are provided for another scenario where the interpretation of the SFI 408 is again applied only to a set of flexible sub-bands 706 within the SBFD symbols 720, but these are indicated as downlink in the SFI 408. Thus, these behaviors may apply to symbols 0-3 in the example slot 404 of FIG. 8. More particularly, if an SFI-index field value in DCI format 2_0 402 indicates the set of sub-band(s) 706 or resources 802 in SBFD symbols 720 of the slot as downlink, the UE behavior may be as follows for these now effectively downlink sub-band resources. Firstly, the UE receives PDSCH and CSI-RS triggered by DL DCI in the one or more downlink sub-band(s) (i.e., the resources 802). Secondly, the UE receives PDSCH and CSI configured by higher-layer in the downlink sub-band(s) unless UE detects UL-DCI scheduling uplink transmission in the uplink sub-band 704. Thirdly, the UE monitors the PDCCH candidate, and thus the UE receives the PDCCH. Fourthly, the UE receives the DL-PRS, which may be received in non-contiguous resources if the uplink sub-band 704 is in the middle of the carrier such as illustrated in FIG. 8. Fifthly, the UE transmits SRS, PUCCH, PUSCH or PRACH in the uplink sub-band 704 when triggered by UL-DCI. Finally, the UE transmits SRS, PUCCH, PUSCH or PRACH configured by higher layer in the uplink sub-band 704 unless UE detects DL-DCI scheduling PDSCH or CSI-RS. In this case, the UE follows the uplink cancellation timeline based on UE partial-cancellation capability such as described with respect to FIG. 5.

Thus, in this scenario, the UE may receive data in the downlink sub-band or resources 802 if triggered by DCI or by RRC and monitor the PDCCH, similar to in the example of FIG. 4. In the uplink sub-band 704, the UE may also receive or transmit data configured either by RRC or by DCI. However, if there is a conflict between an uplink transmission configured by RRC in the uplink resources 804 and downlink data scheduled by DCI in resources 802, the UE may cancel the uplink transmission based on timeline 508 because the DCI DL data has higher priority than the RRC uplink data.

In a third case, UE behaviors are provided in a scenario where there is an uplink sub-band 704 and the network indicates the flexible resources 802 as uplink via SFI 408. These behaviors may apply, for example, to symbol 6 in slot 404 of FIG. 8. More particularly, if an SFI-index field value in DCI format 2_0 402 indicates the set of sub-band(s) 706 or resources 802 in SBFD symbols 720 of the slot 404 as uplink, the whole slot is uplink and guard band, and the UE behaviors are then as follows for these resources 802. Firstly, the UE cancels PDSCH and CSI-RS reception configured by higher layer. Secondly, the UE does not expect to receive DCI for PDSCH or CSI-RS reception. Thirdly, the UE does not receive PDCCH. Fourthly, the UE does not receive DL-PRS. Fifthly, the UE transmits SRS, PUCCH, PUSCH or PRACH in the uplink sub-band 704 when triggered by UL-DCI. Sixthly, the UE transmits SRS, PUCCH, PUSCH or PRACH configured by higher layer in the uplink sub-band 704. Finally, the UE does not expect to receive a DL DCI.

Thus, in this case, the entire SBFD symbol 720 effectively becomes uplink, and the resources 802, 804 in this symbol, including the guard band, becomes unavailable for downlink transmission. Therefore, any downlink data scheduled by DCI or RRC in resources 802 may be dropped, and because the UE 104 does not monitor PDCCH in uplink symbols, the UE does not expect to receive a DCI to schedule any downlink data in these resources 802. The UE also does not expect to receive CSI-RS in these uplink symbols, but the UE may transmit uplink in the resources 802, 804 either by DCI or by RRC.

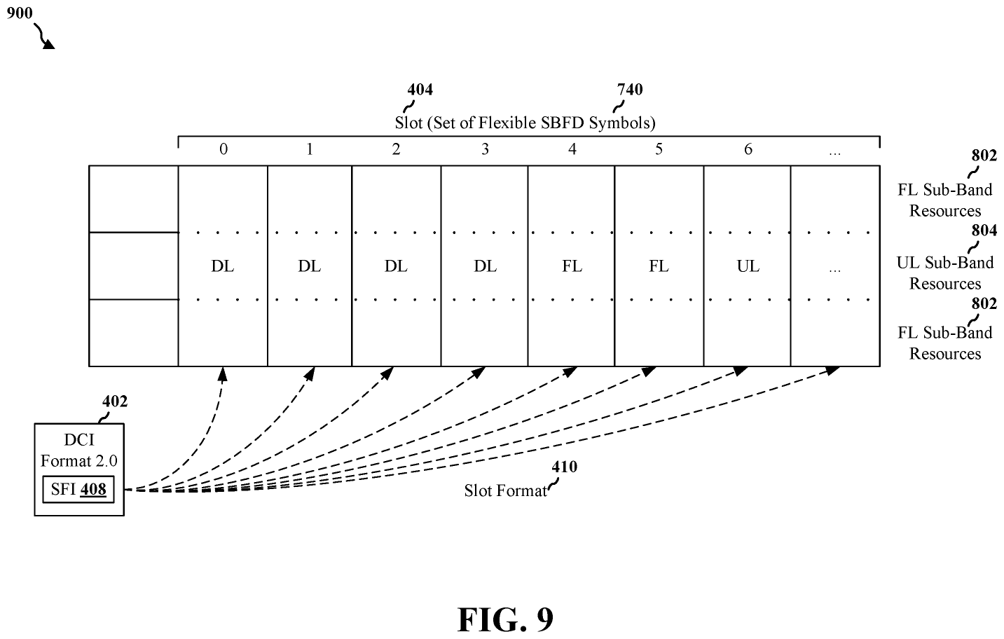

FIG. 9 presents an example 900 of a scenario where the UE 104 detects the SFI 408 in DCI format 2_0 402 in SBFD flexible symbols 740 similar to the example of FIG. 8, but in this case, the SFI 408 is applicable to the whole symbol 740 rather than only the flexible sub-bands 706, effectively causing the symbol to fallback from SBFD to TDD. Here, the UE 104 may similarly apply different behaviors to FL resources 802 and UL resources 804 depending on the SFI 408, although the behaviors may be different than those applied to the SBFD symbol 720 in FIG. 8. More specifically, for a set of SBFD symbols 740 of slot 404 indicated to a UE as flexible by tdd-UL-DL-ConfigurationCommon and tdd-UL-DLConfigurationDedicated if provided, or when tdd-UL-DL-ConfigurationCommon and tdd-UL-DLConfigurationDedicated are not provided to the UE, and configured with UL sub-band 704, and if the UE detects DCI format 2_0 402 providing format 410 for the slot 404 using a slot format value other than 255, the UE 104 may apply one of different sets of behaviors depending on the SFI 408.

In a first case, UE behaviors are presented in a scenario where if an SFI-index field value in DCI format 2_0 402 indicates the set of symbols 740 of the slot as flexible, then the SBFD symbol 702 falls back to a SFI-flexible symbol such as symbol 406 in FIG. 4. Thus, the UE may override the uplink sub-band 704 and the guard band back into flexible resources such as shown by FL symbols 4 and 5 in FIG. 4. That is, instead of having an uplink sub-band 704 and a guard band in between flexible sub-bands 706, the whole SBFD symbol 740 effectively becomes flexible, as illustrated here by the same FL symbols 4 and 5 in the example of FIG. 9. Then, the UE may follow the same behaviors as described with respect to FIG. 4 for these symbols indicated as flexible by SFI 408. For example, the UE receives PDSCH and CSI-RS triggered by DL DCI in resources 802, 804, and the UE transmits SRS, PUCCH, PUSCH or PRACH in the resources 802, 804 if triggered by UL-DCI. The UE does not receive PDSCH and CSI configured by higher-layer in resources 802, 804, does not transmit SRS, PUCCH, PUSCH or PRACH configured by higher layer in resources 802, 804, and does not monitor the PDCCH candidate or receive the PDCCH in resources 802, 804. The UE does receive the DL-PRS in resources 802, 804.

In a second case, UE behaviors are presented in a scenario where if an SFI-index field value in DCI format 2_0 402 indicates the set of symbols 740 of the slot as downlink, the UE falls back to a SFI-downlink symbol by overriding the flexible sub-bands 706, uplink sub-band 704 and guard sub-bands into downlink resources such as shown by DL symbols 0-3 in FIG. 4. Thus, the entire symbol 740 effectively becomes downlink, as illustrated here by the same DL symbols 0-3 in the example of FIG. 9. In this case, the UE only receives downlink data in this set of symbols 740. In addition, the UE maintains the same behavior described with respect to FIG. 4 in these symbols indicated as downlink by SFI 408. For example, the UE receives PDSCH and CSI-RS if triggered by DL DCI in the resources 802, 804. The UE receives PDSCH and CSI configured by higher-layer in the resources 802, 804. The UE monitors the PDCCH candidate and thus the UE receives the PDCCH in resources 802, 804. The UE receives the DL-PRS in the resources 802, 804. However, the UE does not expect to receive a UL DCI in the resources 802, 804. Thus, in this scenario, the UE may receive but not transmit data in these symbols, following the same behavior as described with respect to FIG. 4. If there is any data specific to uplink configured or scheduled in these symbols, it is dropped.

In a third case, UE behaviors are presented in a scenario where if an SFI-index field value in DCI format 2_0 402 indicates the set of symbols 740 of the slot as uplink, the UE 104 falls back to a SFI-uplink symbol by overriding the flexible sub-bands 706 and guard sub-bands into uplink resources such as shown by UL symbol 6 in FIG. 4. Thus, the entire symbol 740 effectively becomes uplink, as illustrated here by the same UL symbol 6 in the example of FIG. 9. In this case, the UE only transmits uplink in this set of symbols 740. In addition, the UE maintains the same behavior described with respect to FIG. 4 in these symbols indicated as uplink by SFI 408. For example, the UE transmits SRS, PUCCH, PUSCH or PRACH in the resources 802, 804 when triggered by UL-DCI. The UE also transmits SRS, PUCCH, PUSCH or PRACH configured by higher layer in the resources 802, 804. However, the UE does not expect to receive a DL DCI in the resources 802, 804. Thus, in this scenario, the whole symbol effectively becomes uplink, and the UE does not expect to receive any downlink DCI in these symbols. Instead, the UE transmits uplink data configured by DCI or RRC in these symbols.

Additionally, in each of the above three cases, the UE 104 drops SBFD-specific signals and/or channels. These signals or channels may be based on configurations specific to SBFD transmission and reception. For example, after the network first sends by RRC to the UE the time and frequency parameters for SBFD symbol 702, the base station 102 may send configurations for certain dedicated signals or channels in certain sub-bands for uplink, downlink, and measurement. For instance, for uplink, the base station may provide a configuration of an SRS having a specific beam, power control, or frequency resources in a given sub-band. For downlink, the base station may provide a configuration of CSI-RS within a specific sub-band. For measurement, the downlink or uplink configuration parameters may be specified to consider cross link interference (CLI) with other sub-bands associated with the same symbol. Thus, these dedicated configurations may be optimized for SBFD operation, given that not all frequencies associated with a SBFD symbol may be available for these signals or channels. However, if downlink or uplink data is configured with a given parameter for SBFD, but the SBFD symbol 702 falls back to a TDD symbol as a result of the SFI indication in FIG. 9, then this SBFD-specific configuration may no longer be valid or needed for these symbols. Thus, the UE may drop the associated SRS, CSI-RS, or other SBFD-specific signal or channel.

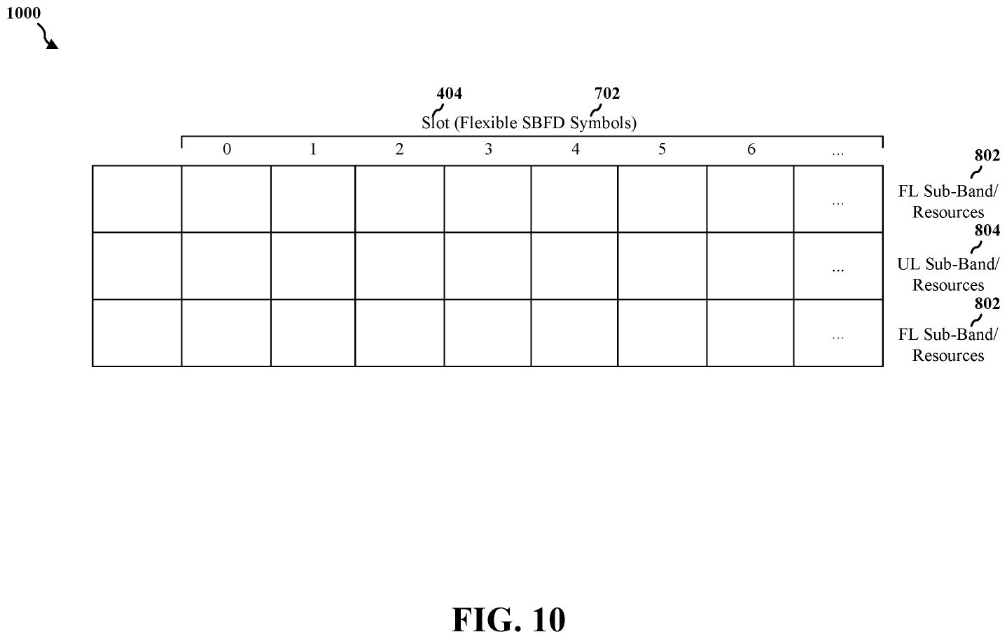

FIG. 10 presents an example 1000 of a scenario where the UE 104 does not detect the SFI 408 indicated in DCI format 2_0 402 in SBFD flexible symbols 702. In such case where the UE is configured to monitor for DCI format 2_0 402 but it does not detect it, one of multiple alternatives of UE behaviors may be applied in this scenario. More specifically, for a set of SBFD symbols 702 of slot 404 indicated to UE 104 as flexible by tdd-UL-DL-ConfigurationCommon and tdd-UL-DLConfigurationDedicated if provided, or when tdd-UL-DL-ConfigurationCommon and tdd-UL-DLConfigurationDedicated are not provided to the UE, and configured with UL sub-band 704, and if the UE does not detect DCI format 2_0 402 providing slot format 410 for the slot 404, the UE may apply one of multiple alternative sets of specified behaviors.

In a first alternative, the UE 104 may apply the behaviors described with respect to FIG. 6 only within the flexible sub-band 706. More specifically, in the FL resources 802, the UE receives PDSCH and CSI-RS only by downlink grant, the UE receives PDCCH, the UE receives DL-PRS, and the UE transmits uplink data by downlink grant or uplink data configured by higher-layer if an enable configured uplink parameter (enableConfiguredUL) is provided. Thus, the flexible sub-band 706 may be restricted to uplink and downlink communication by DCI, while downlink or uplink data configured by RRC, other than uplink data associated with enableConfiguredUL, may be dropped. In the latter case, the UE 104 may follow an uplink cancellation timeline based on UE partial-cancellation capability such as described with respect to FIG. 5. Thus, in the flexible sub-band 706, if the UE is not provided with the enabled configured uplink configuration, the UE may cancel the higher-layer configured uplink transmission based on timeline 508 or T_{proc,2} 506. If the UE is provided with the enabled configured uplink configuration, it may transmit the uplink data configured by RRC. These behaviors similar to that of FIG. 6 apply only within the FL resources 802, not UL resources 804. In the uplink sub-band 704 or UL resources 804, the UE may transmit uplink data scheduled by downlink grant, or the UE may transmit uplink data configured by RRC. Thus, in the uplink sub-band 704, the restrictions of the flexible sub-band 706 are lifted.

In a second alternative, the UE 104 may apply the behaviors described with respect to FIG. 6 within the entire SBFD symbol 702, including the flexible sub-band(s) 706 and uplink sub-band 704. More specifically, in the flexible sub-band 706 or resources 802, the UE receives PDSCH or CSI-RS only by downlink grant, receives PDCCH, receives DL-PRS, transmits uplink data by uplink grant, or transmits uplink data configured by higher-layer if an enable configured uplink parameter (enableConfiguredUL) is provided. In the uplink sub-band 704 or resources 804, the UE may transmit uplink data by uplink grant, or transmit uplink data configured by higher-layer if a SBFD enable configured uplink parameter (enableConfiguredUL-SBFD) is provided. The SBFD enable configured uplink parameter may be similar to the enable configured uplink parameter (enableConfiguredUL) but applied for SBFD symbols 702 instead of TDD symbols such as symbols 406 in FIG. 6. For both resources 802, 804, the UE may also follow an uplink cancellation timeline based on UE partial-cancellation capability such as described with respect to FIG. 5.

In a third alternative, where the UE 104 is configured to monitor the DCI format 2_0 402 but it does not detect the DCI, the UE may apply different behaviors than those described with respect to FIG. 6. In this case, in UL resources 804, the UE 104 may transmit uplink data by uplink grant only in the uplink sub-band 704. The flexible sub-band(s) 706 are reserved, and thus the UE may not receive or transmit any data in FL resources 802. In the UL resources 804, in addition to transmitting uplink data by uplink grant, the UE may transmit uplink data configured by RRC if no DL-DCI is received scheduling data in the SBFD symbols 702, or the UE may transmit uplink data configured by higher-layer if a SBFD enable configured uplink parameter (enableConfiguredUL-SBFD) is provided. Thus, the network may essentially freeze the flexible sub-band(s) 706 and allow only the transmission of data in the uplink sub-band 704.

In various aspects, the UE 104 may determine which sets of the aforementioned behaviors to follow when the UE detects the DCI format 2_0 402, based on an RRC configuration or the DCI. Specifically, when the UE 104 detects DCI format 2_0 402, the UE 104 may follow either the behaviors described with respect to FIG. 8 (where the SFI 408 is applicable to FL resources 802), or the behaviors described with respect to FIG. 9 (where the SFI 408 is applicable to the whole SBFD symbol 702), depending on either an RRC configuration parameter or a field indication in the DCI format 2_0 402 identifying which set of behaviors to follow. For example, either the RRC parameter or the DCI field may indicate to the UE 104 whether the SFI 408 applies only to the flexible sub-band(s) 706, as illustrated in SBFD symbol 720 of FIG. 7, or the entire SBFD symbol including uplink sub-band 704 as well, as illustrated in SBFD symbol 740 of FIG. 7, and thus which set of behaviors the UE is to apply. This indication may be helpful since the network may intend the UE to follow different interpretations for different sets of symbols 702. This allows for greater flexibility and adaptability in managing the UE's behavior in response to different network conditions or requirements.

In various aspects, a rule may be provided for SBFD-aware UEs to support the aforementioned behaviors. In this rule, the SBFD-aware UE may expect to receive DCI format 2-0 402 in SBFD symbols 702 indicating a set of these flexible symbols or resources as flexible, uplink or downlink. More specifically, for a set of SBFD symbols 702 of slot 404 that are indicated as flexible by tdd-UL-DL-ConfigurationCommon or tdd-ULDL-ConfigurationDedicated, or when tdd-UL-DL-ConfigurationCommon and tdd-UL-DLConfigurationDedicated are not provided to the UE, the UE 104 expects to detect DCI format 2_0 402 with an SFI-index field value indicating a subset of the set of SBFD symbols 702 of the slot 404 as uplink/downlink, respectively, or as flexible. Thus, the UE may expect to receive this DCI format 2_0 402 in one of the SBFD flexible symbols 702, rather than in a TDD symbol or other symbol indicating the set of SBFD symbols 702 such as illustrated in FIGS. 8 and 9. For instance, in an alternative to the examples of FIGS. 8 and 9, the UE 104 may receive DCI format 2_0 402 in symbol 0 of the set of flexible SBFD symbols 702, and the SFI 408 may apply to the remaining subset of SBFD symbols 702 indicated by symbols 1 and onward.

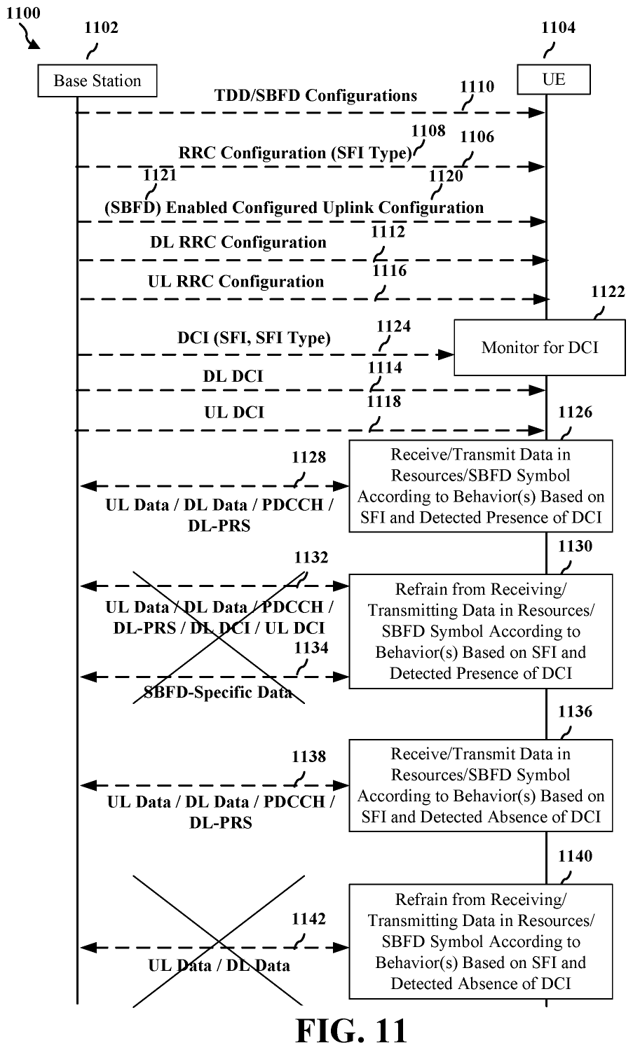

FIG. 11 illustrates an example 1100 of a call flow diagram between a base station 1102 and a UE 1104. Here, base station 1102 may correspond to base station 102, 310, and UE 1104 may correspond to UE 104, 350. Initially, the UE 1104 may receive a RRC configuration 1106 indicating a SFI type 1108. Alternatively, the SFI type 1108 may be indicated in DCI format 2_0 402. In this context, the SFI type 1108 determines how the UE interprets SFI 408 for SBFD symbols 702, and consequently, how the UE behaves when it detects DCI format 2-0 402 affecting such symbols. For instance, the SFI type 1108 may indicate the first interpretation of the SBFD symbol 720 as shown in FIG. 7 and the SFI 408 described with respect to FIG. 8. In this interpretation, the SFI 408 is applicable only to FL resources 802, and thus the SFI 408 only influences the flexible sub-band(s) 706. Alternatively, the SFI type 1108 may indicate the second interpretation of the SBFD symbol 740 as shown in FIG. 7 and the SFI 408 described with respect to FIG. 9. In this interpretation, the SFI 408 is applicable to the whole symbol including FL resources 802 and UL resources 804, and thus the SFI 408 affects both the uplink sub-band 704 and flexible sub-bands 706.

The UE may receive a variety of configurations and grants. These may include TDD and SBFD configurations 1110, downlink RRC configurations 1112 or downlink grants 1114, uplink RRC configurations 1116 or uplink grants 1118, enabled configured uplink configurations 1120 and SBFD enabled configured uplink configurations 1121, or other signaling. These configurations may determine the timing of slots 404, the location of frequency bands, sub-bands 704, 706 or resources 802, 804, and various types of data that the UE is expected to receive from or transmit to the base station in configured, flexible SBFD symbols 702. For instance, these configurations and grants may indicate different types of data such as PDSCH and CSI triggered by DL DCI, PDSCH and CSI configured by higher-layer, PDCCH, DL-PRS, SRS, PUCCH, PUSCH, PRACH triggered by UL DCI, SRS, PUCCH, PUSCH, PRACH triggered by higher layer, parameters related to partial cancellation or timelines 508, and SBFD-specific signals or channels. All of these different types of data may be in uplink sub-bands 704 or flexible sub-bands 706 of flexible SBFD symbols 702 as indicated in the TDD and SBFD configurations 1110.

After receiving various ones of the aforementioned higher layer configurations, but before receiving dynamic grants for downlink or uplink data, the UE may at block 1122 monitor for a DCI 1124 having a DCI format 2_0 402. For example, the UE may use a pre-configured search process to look for the DCI 1124, scanning the appropriate frequency bands and time slots based on its current configuration and network scheduling. If present, the DCI 1124 may include SFI 408 indicating a downlink, uplink, or flexible slot format 410 for upcoming flexible SBFD symbols 702 which include the aforementioned, various types of configured or scheduled downlink data or uplink data. Depending on whether the UE detects the presence of the DCI 1124, or an absence of the DCI 1124 through failure to detect its presence or otherwise, and depending on the slot format 410 for these SBFD symbols 702 indicated in SFI 408 when the DCI 1124 is present, the UE may perform one of multiple sets of behaviors in terms of reception, transmission, refrained reception, or refrained transmission of data in these symbols. These behaviors can be based on only the FL resources 802, as per the first interpretation discussed with respect to FIG. 8, the entire SBFD symbol including FL resources 802 and UL resources 804, as per the second interpretation discussed with respect to FIG. 9, or the absence of DCI 1124, as described with respect to FIG. 10.

In one example, at block 1126, the UE may receive or transmit data 1128 in either the FL resources 802 or the entire SBFD symbol 702 according to one of multiple behaviors based on the SFI 408 and a detected presence of the DCI format 2_0 402. For example, the UE may receive DL data by grant or higher layer, PDCCH, DL-PRS, or transmit UL data by grant or higher layer, depending on whether the SFI 408 is flexible, downlink or uplink, and depending on whether the data is in the flexible sub-band(s) 706 or the uplink sub-band 704, such as described with to FIG. 8 or 9. In another example, at block 1130, the UE may refrain from receiving or refrain from transmitting data 1132 in either the FL resources 802 or the entire SBFD symbol 702 according to one of multiple behaviors based on the SFI 408 and a detected presence of the DCI format 2_0 402. For example, the UE may not receive DL data by grant or higher layer, PDCCH, DL-PRS, DL DCI, UL DCI, and may not transmit UL data by grant or higher layer, depending on whether the SFI 408 is flexible, downlink or uplink, and depending on whether the data is in the flexible sub-band(s) 706 or the uplink sub-band 704, such as described with respect to FIG. 8 or 9. The UE may also refrain from transmitting SBFD-specific data 1134 or channels, such as described with respect to FIG. 9. In another example, at block 1136, the UE may receive or transmit data 1138 in either the FL resources 802 or the entire SBFD symbol 702 according to one of multiple behaviors based on a detected absence of the DCI format 2_0 402. For example, the UE may receive DL data by grant or higher layer, PDCCH, DL-PRS, or transmit UL data by grant or higher layer, depending on whether the data is in the flexible sub-band(s) 706 or the uplink sub-band 704, such as described with respect to FIG. 10. In a further example, at block 1140, the UE may refrain from receiving or transmitting data 1142 in either the FL resources 802 or the entire SBFD symbol 702 according to one of multiple behaviors based on a detected absence of the DCI format 2_0 402. For example, the UE may not receive DL data and may not transmit UL data, depending on whether the data is in the flexible sub-band(s) 706 or the uplink sub-band 704, such as described with respect to FIG. 10.

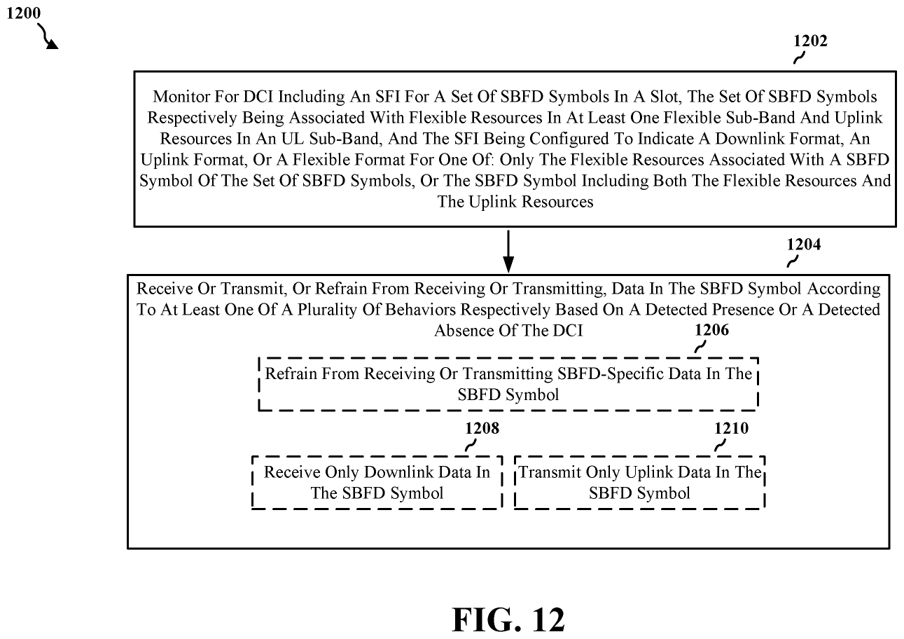

FIG. 12 is a flowchart 1200 of an example method or process for wireless communication. The method may be performed by a UE, such as the UE 104, 350, 1104, the apparatus 1302, or its components as described herein.

At block 1202, the UE may monitor for DCI including a SFI for a set of SBFD symbols in a slot, the set of SBFD symbols respectively being associated with flexible resources in at least one flexible sub-band and uplink resources in an UL sub-band, and the SFI being configured to indicate a downlink format, an uplink format, or a flexible format for one of: only the flexible resources associated with a SBFD symbol of the set of SBFD symbols, or the SBFD symbol including both the flexible resources and the uplink resources. For example, block 1202 may be performed by monitor component 1340. For instance, referring to the Figures, the controller(s)/processor(s) 359 or RX processor(s) 356 of UE at block 1122 may monitor for DCI 1124 including SFI 408 for a set of SBFD symbols 702 in slot 404. The set of SBFD symbols 702 may respectively be associated with FL resources 802 in at least one flexible sub-band 706 and UL resources 804 in uplink sub-band 704. The SFI 408 is configured to indicate slot format 410 for each of the SBFD symbols 720, 740 as downlink, uplink, or flexible. More particularly, the slot format 410 may be indicated for only FL resources 802 associated with SBFD symbols 720, or the slot format 410 may be indicated for the entire SBFD symbol 740 including both FL resources 802 and UL resources 804.

At block 1204, the UE may receive or transmit, or refrain from receiving or transmitting, data in the SBFD symbol according to at least one of a plurality of behaviors respectively based on a detected presence or a detected absence of the DCI. For example, block 1204 may be performed by data component 1342. For instance, referring to the Figures, in one example, the controller(s)/processor(s) 359, RX processor(s) 356, or TX processor(s) 368 of the UE may receive or transmit data 1128 at block 1126 in SBFD symbol 702 according to at least one of a plurality of behaviors described with respect to FIG. 8 or 9 based on a detected presence of DCI 1124 at block 1122. In another example, the controller(s)/processor(s) 359, RX processor(s) 356, or TX processor(s) 368 of the UE may refrain from receiving or transmitting data 1132 at block 1130 in SBFD symbol 702 according to at least one of a plurality of behaviors described with respect to FIG. 8 or 9 based on a detected presence of DCI 1124 at block 1122. In another example, the controller(s)/processor(s) 359, RX processor(s) 356, or TX processor(s) 368 of the UE may receive or transmit data 1138 at block 1136 in SBFD symbol 702 according to at least one of a plurality of behaviors described with respect to FIG. 10 based on a detected absence of DCI 1124 at block 1122. In a further example, the controller(s)/processor(s) 359, RX processor(s) 356, or TX processor(s) 368 of the UE may refrain from receiving or transmitting data 1142 at block 1140 in SBFD symbol 702 according to at least one of a plurality of behaviors described with respect to FIG. 10 based on a detected absence of DCI 1124.

In one example, in response to the SFI being configured to indicate the flexible format for the only the flexible resources, the plurality of behaviors based on the detected presence of the DCI includes: reception in the flexible resources of downlink data triggered by a downlink DCI, refrained reception in the flexible resources of downlink data triggered by a downlink RRC configuration, refrained reception in the flexible resources of a PDCCH, reception in the flexible resources of a DL-PRS, transmission in the uplink resources or the flexible resources of uplink data triggered by an uplink DCI, refrained transmission in the flexible resources of uplink data triggered by an uplink RRC configuration, and transmission in the uplink resources of uplink data triggered by an uplink RRC configuration in response to a detected absence of a downlink DCI scheduling downlink data in the flexible resources. For instance, referring to the Figures, if SFI 408 indicates only FL resources 802 of SBFD symbols 720 are flexible such as symbols 4 and 5 in FIG. 8, then at blocks 1126, 1130, the UE may receive or transmit or refrain from receiving or transmitting according to at least one of multiple behaviors. In particular, the UE may receive in FL resources 802 DL data triggered by downlink grants 1114, the UE may not receive in FL resources 802 DL data triggered by DL RRC configuration 1112 or higher layers, the UE may not receive in FL resources 802 PDCCH in CORESET 504, the UE may receive in FL resources 802 DL-PRS, the UE may transmit in UL resources 804 or FL resources 802 UL data triggered by uplink grants 1118, the UE may not transmit in FL resources 802 UL data triggered by RRC configurations 1116 or higher layers, or the UE may transmit in UL resources 804 UL data triggered by RRC configurations 1116 or higher layers in response to undetected downlink grants 1114 scheduling DL data in time overlapping FL resources 802.

In one example, in response to the SFI being configured to indicate the downlink format for the only the flexible resources, the plurality of behaviors based on the detected presence of the DCI includes: reception in the flexible resources of downlink data triggered by a downlink DCI, reception in the flexible resources of downlink data triggered by a downlink RRC configuration in response to a detected absence of an uplink DCI scheduling uplink data in the uplink resources, reception in the flexible resources of a PDCCH, reception in the flexible resources of a DL-PRS, transmission in the uplink resources of uplink data triggered by an uplink DCI, and transmission in the uplink resources of uplink data triggered by an uplink RRC configuration in response to a detected absence of a downlink DCI scheduling downlink data in the flexible resources. For instance, referring to the Figures, if SFI 408 indicates only FL resources 802 of SBFD symbols 720 are downlink such as symbols 0-3 in FIG. 8, then at blocks 1126, 1130, the UE may receive or transmit or refrain from receiving or transmitting according to at least one of multiple behaviors. In particular, the UE may receive in FL resources 802 DL data triggered by downlink grants 1114, the UE may receive in FL resources 802 DL data triggered by DL RRC configuration 1112 or higher layers in response to undetected uplink grants 1118 scheduling UL data in time-overlapping UL resources 804, the UE may receive in FL resources 802 PDCCH in CORESET 504, the UE may receive in FL resources 802 DL-PRS, the UE may transmit in UL resources 804 UL data triggered by uplink grants 1118, or the UE may transmit in UL resources 804 UL data triggered by RRC configurations 1116 or higher layers in response to undetected downlink grants 1114 scheduling DL data in time overlapping FL resources 802.

In one example, in response to the SFI being configured to indicate the uplink format for the only the flexible resources, the plurality of behaviors based on the detected presence of the DCI includes: refrained reception in the flexible resources of downlink data triggered by a downlink RRC configuration, refrained reception in the flexible resources of a downlink DCI for downlink data, refrained reception in the flexible resources of a PDCCH, refrained reception in the flexible resources of a DL-PRS, transmission in the uplink resources of uplink data triggered by an uplink DCI, and transmission in the uplink resources of uplink data triggered by an uplink RRC configuration. For instance, referring to the Figures, if SFI 408 indicates only FL resources 802 of SBFD symbols 720 are uplink such as symbol 6 in FIG. 8, then at blocks 1126, 1130, the UE may receive or transmit or refrain from receiving or transmitting according to at least one of multiple behaviors. In particular, the UE may not receive in FL resources 802 DL data triggered by downlink grants 1114, the UE may not receive in FL resources 802 DL data triggered by DL RRC configuration 1112 or higher layers, the UE may not receive in FL resources 802 PDCCH in CORESET 504, the UE may not receive in FL resources 802 DL-PRS, the UE may transmit in UL resources 804 UL data triggered by uplink grants 1118, or the UE may transmit in UL resources 804 UL data triggered by RRC configurations 1116 or higher layers.

In some examples, at block 1206, in response to the SFI being configured to indicate the flexible format for the SBFD symbol including both the flexible resources and the uplink resources, the UE may refrain from receiving or transmitting SBFD-specific data in the SBFD symbol. For example, block 1206 may be performed by data component 1342. For instance, referring to the Figures, if SFI 408 indicates both FL resources 802 and UL resources 804 of SBFD symbols 740 are flexible such as symbols 4 and 5 of FIG. 9, then at block 1130, the controller(s)/processor(s) 359, RX processor(s) 356, or TX processor(s) 368 of the UE may refrain from receiving or transmitting SBFD-specific data 1134 or channels in the SBFD symbol 740.

In some examples, in response to the SFI being configured to indicate the flexible format for the SBFD symbol including both the flexible resources and the uplink resources, the plurality of behaviors based on the detected presence of the DCI includes: reception in the SBFD symbol of downlink data triggered by a downlink DCI, refrained reception in the SBFD symbol of downlink data triggered by a downlink RRC configuration, refrained reception in the SBFD symbol of a PDCCH, reception in the SBFD symbol of a DL-PRS, transmission in the SBFD symbol of uplink data triggered by an uplink DCI, and refrained transmission in the SBFD symbol of uplink data triggered by an uplink RRC configuration. For instance, referring to the Figures, if SFI 408 indicates both FL resources 802 and UL resources 804 of SBFD symbols 740 are flexible such as symbols 4 and 5 of FIG. 9, then at blocks 1126, 1130, the UE may receive or transmit or refrain from receiving or transmitting according to at least one of multiple behaviors. In particular, the UE may receive in SBFD symbol 740 DL data triggered by downlink grants 1114, the UE may not receive in SBFD symbol 740 DL data triggered by DL RRC configuration 1112 or higher layers, the UE may not receive in SBFD symbol 740 PDCCH in CORESET 504, the UE may receive in SBFD symbol 740 DL-PRS, the UE may transmit in SBFD symbol 740 UL data triggered by uplink grants 1118, or the UE may not transmit in SBFD symbol 740 UL data triggered by RRC configurations 1116 or higher layers.

In some examples, at block 1206, in response to the SFI being configured to indicate the downlink format for the SBFD symbol including both the flexible resources and the uplink resources, the UE may refrain from receiving or transmitting SBFD-specific data in the SBFD symbol. Moreover, at block 1208, the UE may receive only downlink data in the SBFD symbol. For example, block 1208 may be performed by data component 1342. For instance, referring to the Figures, if SFI 408 indicates both FL resources 802 and UL resources 804 of SBFD symbols 740 are downlink such as symbols 0-3 of FIG. 9, then at blocks 1126, 1130, the controller(s)/processor(s) 359, RX processor(s) 356, or TX processor(s) 368 of the UE may refrain from receiving or transmitting SBFD-specific data 1134 or channels in the SBFD symbol 740 and may receive only DL data in SBFD symbol 740.

In some examples, in response to the SFI being configured to indicate the downlink format for the SBFD symbol including both the flexible resources and the uplink resources, the plurality of behaviors based on the detected presence of the DCI includes: reception in the flexible resources of downlink data triggered by a downlink DCI, reception in the flexible resources of downlink data triggered by a downlink RRC configuration, reception in the SBFD symbol of a PDCCH, reception in the SBFD symbol of a DL-PRS, and refrained reception in the SBFD symbol of an uplink DCI. For instance, referring to the Figures, if SFI 408 indicates both FL resources 802 and UL resources 804 of SBFD symbols 740 are downlink such as symbols 0-3 in FIG. 9, then at blocks 1126, 1130, the UE may receive or transmit or refrain from receiving or transmitting according to at least one of multiple behaviors. In particular, the UE may receive in FL resources 802 DL data triggered by downlink grants 1114, the UE may receive in FL resources 802 DL data triggered by DL RRC configuration 1112 or higher layers, the UE may receive in FL resources 802 PDCCH in CORESET 504, the UE may receive in FL resources 802 DL-PRS, or the UE may refrain from receiving in SBFD symbol 740 uplink grants 1118.

In some examples, at block 1206, in response to the SFI being configured to indicate the uplink format for the SBFD symbol including both the flexible resources and the uplink resources, the UE may refrain from receiving or transmitting SBFD-specific data in the SBFD symbol. Moreover, at block 1210, the UE may transmit only uplink data in the SBFD symbol. For example, block 1210 may be performed by data component 1342. For instance, referring to the Figures, if SFI 408 indicates both FL resources 802 and UL resources 804 of SBFD symbols 740 are uplink such as symbol 6 of FIG. 9, then at blocks 1126, 1130, the controller(s)/processor(s) 359, RX processor(s) 356, or TX processor(s) 368 of the UE may refrain from receiving or transmitting SBFD-specific data 1134 or channels in the SBFD symbol 740 and may transmit only uplink data in SBFD symbol 740.

In some examples, in response to the SFI being configured to indicate the uplink format for the SBFD symbol including both the flexible resources and the uplink resources, the plurality of behaviors based on the detected presence of the DCI includes: transmission in the uplink resources of uplink data triggered by an uplink DCI, transmission in the uplink resources of uplink data triggered by an uplink RRC configuration, and refrained reception in the SBFD symbol of a downlink DCI. For instance, referring to the Figures, if SFI 408 indicates both FL resources 802 and UL resources 804 of SBFD symbols 740 are uplink such as symbol 6 of FIG. 9, then at blocks 1126, 1130, the UE may receive or transmit or refrain from receiving or transmitting according to at least one of multiple behaviors. In particular, the UE may transmit in UL resources 804 UL data triggered by uplink grants 1118, the UE may transmit in UL resources 804 UL data triggered by RRC configurations 1116 or higher layers, or the UE may refrain from receiving in SBFD symbol 740 downlink grants 1114.

In some examples, the plurality of behaviors based on the detected absence of the DCI includes: reception in the flexible resources of downlink data triggered by a downlink DCI, refrained reception in the flexible resources of downlink data triggered by a downlink RRC configuration, reception in the flexible resources of a PDCCH, reception in the flexible resources of a DL-PRS, transmission in the uplink resources or the flexible resources of uplink data triggered by an uplink DCI, transmission in the flexible resources of uplink data triggered by an uplink RRC configuration in response to an enabled configured uplink configuration, and transmission in the uplink resources of uplink data triggered by an uplink RRC configuration. For instance, referring to the Figures, in response to failing to detect DCI 1124 at block 1122, then at blocks 1136, 1140, the UE may receive or transmit or refrain from receiving or transmitting according to at least one alternative set of multiple behaviors. In particular, the UE may receive in FL resources 802 DL data triggered by downlink grants 1114, the UE may not receive in FL resources 802 DL data triggered by DL RRC configuration 1112 or higher layers, the UE may receive in FL resources 802 PDCCH in CORESET 504, the UE may receive in FL resources 802 DL-PRS, the UE may transmit in UL resources 804 or FL resources 802 UL data triggered by uplink grants 1118, the UE may transmit in FL resources 802 UL data triggered by RRC configurations 1116 or higher layers in response to receiving enabled configured uplink configuration 1120, or the UE may transmit in UL resources 804 UL data triggered by RRC configurations 1116 or higher layers.

In some examples, the plurality of behaviors based on the detected absence of the DCI includes: reception in the flexible resources of downlink data triggered by a downlink DCI, refrained reception in the flexible resources of downlink data triggered by a downlink RRC configuration, reception in the flexible resources of a PDCCH, reception in the flexible resources of a DL-PRS, transmission in the uplink resources or the flexible resources of uplink data triggered by an uplink DCI, transmission in the flexible resources of uplink data triggered by an uplink RRC configuration based on an enabled configured uplink configuration, and transmission in the uplink resources of uplink data triggered by an uplink RRC configuration based on an SBFD enabled configured uplink configuration. For instance, referring to the Figures, in response to failing to detect DCI 1124 at block 1122, then at blocks 1136, 1140, the UE may receive or transmit or refrain from receiving or transmitting according to at least another alternative set of multiple behaviors. In particular, the UE may receive in FL resources 802 DL data triggered by downlink grants 1114, the UE may not receive in FL resources 802 DL data triggered by DL RRC configuration 1112 or higher layers, the UE may receive in FL resources 802 PDCCH in CORESET 504, the UE may receive in FL resources 802 DL-PRS, the UE may transmit in FL resources 802 or UL resources 804 UL data triggered by uplink grants 1118, the UE may transmit in FL resources 802 UL data triggered by RRC configurations 1116 or higher layers based on enabled configured uplink configuration 1120, or the UE may transmit in UL resources 804 UL data triggered by RRC configurations 1116 or higher layers based on SBFD enabled configured uplink configuration 1121.

In some examples, the plurality of behaviors based on the detected absence of the DCI includes: refrained reception or transmission of data in the flexible resources, transmission in the uplink resources of uplink data triggered by an uplink DCI, and transmission in the uplink resources of uplink data triggered by an uplink RRC configuration in response to a detected absence of a downlink DCI scheduling downlink data in the flexible resources or based on an SBFD enabled configured uplink configuration. For instance, referring to the Figures, in response to failing to detect DCI 1124 at block 1122, then at blocks 1136, 1140, the UE may receive or transmit or refrain from receiving or transmitting according to at least a further alternative set of multiple behaviors. In particular, the UE may not receive DL data or transmit UL data in FL resources 802, the UE may transmit in UL resources 804 UL data triggered by uplink grants 1118, or the UE may transmit in UL resources 804 UL data triggered by RRC configurations 1116 or higher layers in response to undetected downlink grants 1114 scheduling DL data in time-overlapping FL resources 802 or based on SBFD enabled configured uplink configuration 1121.

In some examples, whether the SFI indicates a slot format for only the flexible resources, or whether the SFI indicates the slot format for the SBFD symbol including both the flexible resources and the uplink resources, is based on a RRC configuration parameter or a field in the DCI. For instance, referring to the Figures, the UE may determine from SFI type 1108 in RRC configuration 1106 or DCI 1124 whether the SFI 408 indicates slot format 410 for only FL resources 802, such as illustrated by SBFD symbols 720 in FIG. 8, or whether the SFI 408 indicates slot format 410 for both FL resources 802 and UL resources 804, such as illustrated by SBFD symbols 740 in FIG. 9. For example, the UE may determine that the behaviors described with respect to FIG. 8 may apply when the SFI type 1108 is one value, while the behaviors described with respect to FIG. 9 apply when the SFI type 1108 is another value.

In some examples, the DCI is monitored in the set of SBFD symbols, and the SFI is configured to indicate the downlink format, the uplink format, or the flexible format for a subset of the set of SBFD symbols, the subset including the SBFD symbol. For instance, referring to the Figures, the UE at block 1122 may monitor for DCI 1124 in the set of SBFD symbols 702, and the SFI 408 may indicate the slot format 410 (downlink, uplink, or flexible) for a subset of these SBFD symbols 702. Thus, the UE may receive DCI format 2_0 402 in one of the SBFD flexible symbols 702, rather than in a TDD symbol or other symbol indicating the set of SBFD symbols 702 such as illustrated in FIGS. 8 and 9. For instance, in an alternative to the examples of FIGS. 8 and 9, the UE 104 may receive DCI format 2_0 402 in symbol 0 of the set of flexible SBFD symbols 702, and the SFI 408 may apply to the remaining subset of SBFD symbols 702 indicated by symbols 1 and onward.

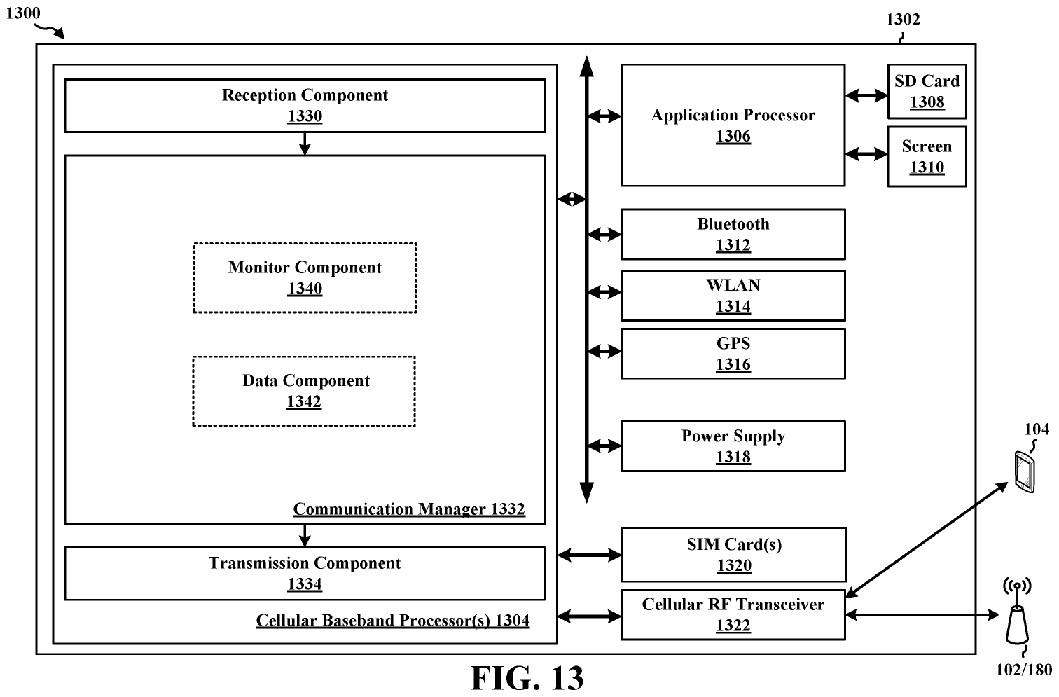

FIG. 13 is a diagram 1300 illustrating an example of a hardware implementation for an apparatus 1302 according to the various aspects of the present disclosure. In one example, the apparatus 1302 may be a UE such as UE 104, 350, 1104 and includes one or more cellular baseband processors 1304 (also referred to as a modem) coupled to a cellular RF transceiver 1322 and one or more subscriber identity modules (SIM) cards 1320, an application processor 1306 coupled to a secure digital (SD) card 1308 and a screen 1310, a Bluetooth module 1312, a wireless local area network (WLAN) module 1314, a Global Positioning System (GPS) module 1316, and a power supply 1318. The one or more cellular baseband processors 1304 communicate through the cellular RF transceiver 1322 with the BS 102. For example, the cellular RF transceiver 1322 may correspond to or include the transmitters 354TX, receivers 354RX, and antennas 352 of UE 350.

The one or more cellular baseband processors 1304 may each include a computer-readable medium/one or more memories. The computer-readable medium/one or more memories may be non-transitory. The one or more cellular baseband processors 1304 are responsible for general processing, including the execution of software stored on the computer-readable medium/one or more memories individually or in combination. The software, when executed by the one or more cellular baseband processors 1304, causes the one or more cellular baseband processors 1304 to, individually or in combination, perform the various functions described supra. The computer-readable medium/one or more memories may also be used individually or in combination for storing data that is manipulated by the one or more cellular baseband processors 1304 when executing software. The one or more cellular baseband processors 1304 individually or in combination further include a reception component 1330, a communication manager 1332, and a transmission component 1334. The communication manager 1332 includes the one or more illustrated components. The components within the communication manager 1332 may be stored in the computer-readable medium/one or more memories and/or configured as hardware within the one or more cellular baseband processors 1304. The one or more cellular baseband processors 1304 may be components of the UE 104, 350, 1104 and may individually or in combination include the one or more memories 360 and/or at least one of the one or more TX processors 368, at least one of the one or more RX processors 356 and at least one of the one or more controllers/processors 359. For example, the computer-readable medium/one or more memories may correspond to or include the one or more memories 360, the reception component 1330 may correspond to or include the one or more RX processors 356, the communication manager 1332 may correspond to or include the one or more controllers/processors 359, and the transmission component 1334 may correspond to or include the one or more TX processors 368. In one configuration, the apparatus 1302 may be a modem chip and include just the one or more baseband processors 1304, and in another configuration, the apparatus 1302 may be the entire UE (e.g., UE 350 of FIG. 3) and include the aforediscussed additional modules of the apparatus 1302.

The communication manager 1332 may include a monitor component 1340 that is configured to monitor for DCI including a SFI for a set of SBFD symbols in a slot, the set of SBFD symbols respectively being associated with flexible resources in at least one flexible sub-band and uplink resources in an UL sub-band, and the SFI being configured to indicate a downlink format, an uplink format, or a flexible format for one of: only the flexible resources associated with a SBFD symbol of the set of SBFD symbols, or the SBFD symbol including both the flexible resources and the uplink resources, such as described in connection with block 1202 of FIG. 12. The communication manager 1332 may also include a data component 1342 that is configured to receive or transmit, or refrain from receiving or transmitting, data in the SBFD symbol according to at least one of a plurality of behaviors respectively based on a detected presence or a detected absence of the DCI, such as described in connection with block 1204 of FIG. 12.

The apparatus may include additional components that perform each of the blocks of the algorithm in the aforementioned flowchart of FIG. 12. As such, each block in the aforementioned flowchart of FIG. 12 may be performed by a component and the apparatus may include one or more of those components. The components may be one or more hardware components specifically configured to carry out the stated processes/algorithm, implemented by one or more processors individually or in combination configured to perform the stated processes/algorithm, stored within a computer-readable medium for implementation by one or more processors, or some combination thereof.

In one configuration, the apparatus 1302, and in particular the one or more cellular baseband processors 1304, includes means for monitoring for DCI including a SFI for a set of SBFD symbols in a slot, the set of SBFD symbols respectively being associated with flexible resources in at least one flexible sub-band and uplink resources in an UL sub-band, and the SFI being configured to indicate a downlink format, an uplink format, or a flexible format for one of: only the flexible resources associated with a SBFD symbol of the set of SBFD symbols, or the SBFD symbol including both the flexible resources and the uplink resources. The apparatus 1302, and in particular the one or more cellular baseband processors 1304, also includes means for receiving or transmitting, or refraining from receiving or transmitting, data in the SBFD symbol according to at least one of a plurality of behaviors respectively based on a detected presence or a detected absence of the DCI.

The aforementioned means may be one or more of the aforementioned components of the apparatus 1302 configured to perform the functions recited by the aforementioned means. Moreover, as described supra, the apparatus 1302 may include the one or more TX Processors 368, the one or more RX Processors 370, and the one or more controllers/processors 359. As such, in one configuration, the aforementioned means may be at least one of the one or more TX Processors 368, at least one of the one or more RX Processors 356, or at least one of the one or more controllers/processors 359 individually or in any combination configured to perform the functions recited by the aforementioned means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, a processor, at least one processor, and/or one or more processors, individually or in combination, configured to perform or operable for performing a plurality of actions (such as the functions described supra) is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

Similarly as used herein, a memory, at least one memory, a computer-readable medium, and/or one or more memories, individually or in combination, configured to store or having stored thereon instructions executable by one or more processors for performing a plurality of actions (such as the functions described supra) is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, a computer-readable medium, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, a second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, in combination, execute the respective subset of instructions to accomplish performing actions X, Y, and Z. Alternatively, three processors may access one of three different memories each storing one of instructions for performing X, Y, or Z, and the three processors may in combination execute the respective subset of instruction to accomplish performing actions X, Y, and Z. Alternatively, a single processor may execute the instructions stored on a single memory, or distributed across multiple memories, to accomplish performing actions X, Y, and Z.

The following examples are illustrative only and may be combined with aspects of other embodiments or teachings described herein, without limitation.

Clause 1. An apparatus for wireless communication, comprising: one or more memories; and one or more processors each communicatively coupled with at least one of the one or more memories, the one or more processors, individually or in any combination, operable to cause the apparatus to: monitor for downlink control information (DCI) including a slot format indication (SFI) for a set of sub-band full duplex (SBFD) symbols in a slot, the set of SBFD symbols respectively being associated with flexible resources in at least one flexible sub-band and uplink resources in an uplink (UL) sub-band, and the SFI being configured to indicate a downlink format, an uplink format, or a flexible format for one of: only the flexible resources associated with a SBFD symbol of the set of SBFD symbols, or the SBFD symbol including both the flexible resources and the uplink resources; and receive or transmit, or refrain from receiving or transmitting, data in the SBFD symbol according to at least one of a plurality of behaviors respectively based on a detected presence or a detected absence of the DCI.

Clause 2. The apparatus of clause 1, wherein in response to the SFI being configured to indicate the flexible format for the only the flexible resources, the plurality of behaviors based on the detected presence of the DCI includes: reception in the flexible resources of downlink data triggered by a downlink DCI, refrained reception in the flexible resources of downlink data triggered by a downlink radio resource control (RRC) configuration, refrained reception in the flexible resources of a physical downlink control channel (PDCCH), reception in the flexible resources of a downlink positioning reference signal (DL-PRS), transmission in the uplink resources or the flexible resources of uplink data triggered by an uplink DCI, refrained transmission in the flexible resources of uplink data triggered by an uplink RRC configuration, and transmission in the uplink resources of uplink data triggered by an uplink RRC configuration in response to a detected absence of a downlink DCI scheduling downlink data in the flexible resources.

Clause 3. The apparatus of clause 1 or clause 2, wherein in response to the SFI being configured to indicate the downlink format for the only the flexible resources, the plurality of behaviors based on the detected presence of the DCI includes: reception in the flexible resources of downlink data triggered by a downlink DCI, reception in the flexible resources of downlink data triggered by a downlink radio resource control (RRC) configuration in response to a detected absence of an uplink DCI scheduling uplink data in the uplink resources, reception in the flexible resources of a physical downlink control channel (PDCCH), reception in the flexible resources of a downlink positioning reference signal (DL-PRS), transmission in the uplink resources of uplink data triggered by an uplink DCI, and transmission in the uplink resources of uplink data triggered by an uplink RRC configuration in response to a detected absence of a downlink DCI scheduling downlink data in the flexible resources.

Clause 4. The apparatus of any of clauses 1 to 3, wherein in response to the SFI being configured to indicate the uplink format for the only the flexible resources, the plurality of behaviors based on the detected presence of the DCI includes: refrained reception in the flexible resources of downlink data triggered by a downlink radio resource control (RRC) configuration, refrained reception in the flexible resources of a downlink DCI for downlink data, refrained reception in the flexible resources of a physical downlink control channel (PDCCH), refrained reception in the flexible resources of a downlink positioning reference signal (DL-PRS), transmission in the uplink resources of uplink data triggered by an uplink DCI, and transmission in the uplink resources of uplink data triggered by an uplink RRC configuration.

Clause 5. The apparatus of clause 1, wherein in response to the SFI being configured to indicate the flexible format for the SBFD symbol including both the flexible resources and the uplink resources, the one or more processors, individually or in any combination, are operable to cause the apparatus to: refrain from receiving or transmitting SBFD-specific data in the SBFD symbol.

Clause 6. The apparatus of clause 1 or clause 5, wherein in response to the SFI being configured to indicate the flexible format for the SBFD symbol including both the flexible resources and the uplink resources, the plurality of behaviors based on the detected presence of the DCI includes: reception in the SBFD symbol of downlink data triggered by a downlink DCI, refrained reception in the SBFD symbol of downlink data triggered by a downlink radio resource control (RRC) configuration, refrained reception in the SBFD symbol of a physical downlink control channel (PDCCH), reception in the SBFD symbol of a downlink positioning reference signal (DL-PRS), transmission in the SBFD symbol of uplink data triggered by an uplink DCI, and refrained transmission in the SBFD symbol of uplink data triggered by an uplink RRC configuration.

Clause 7. The apparatus of any of clauses 1, 5 and 6, wherein in response to the SFI being configured to indicate the downlink format for the SBFD symbol including both the flexible resources and the uplink resources, the one or more processors, individually or in any combination, are operable to cause the apparatus to: refrain from receiving or transmitting SBFD-specific data in the SBFD symbol; and receive only downlink data in the SBFD symbol.

Clause 8. The apparatus of any of clauses 1 and 5 to 7, wherein in response to the SFI being configured to indicate the downlink format for the SBFD symbol including both the flexible resources and the uplink resources, the plurality of behaviors based on the detected presence of the DCI includes: reception in the flexible resources of downlink data triggered by a downlink DCI, reception in the flexible resources of downlink data triggered by a downlink radio resource control (RRC) configuration, reception in the SBFD symbol of a physical downlink control channel (PDCCH), reception in the SBFD symbol of a downlink positioning reference signal (DL-PRS), and refrained reception in the SBFD symbol of an uplink DCI.

Clause 9. The apparatus of any of clauses 1 and 5 to 8, wherein in response to the SFI being configured to indicate the uplink format for the SBFD symbol including both the flexible resources and the uplink resources, the one or more processors, individually or in any combination, are operable to cause the apparatus to: refrain from receiving or transmitting SBFD-specific data in the SBFD symbol; and transmit only uplink data in the SBFD symbol.

Clause 10. The apparatus of any of clauses 1 and 5 to 9, wherein in response to the SFI being configured to indicate the uplink format for the SBFD symbol including both the flexible resources and the uplink resources, the plurality of behaviors based on the detected presence of the DCI includes: transmission in the uplink resources of uplink data triggered by an uplink DCI, transmission in the uplink resources of uplink data triggered by an uplink RRC configuration, and refrained reception in the SBFD symbol of a downlink DCI.

Clause 11. The apparatus of clause 1, wherein the plurality of behaviors based on the detected absence of the DCI includes: reception in the flexible resources of downlink data triggered by a downlink DCI, refrained reception in the flexible resources of downlink data triggered by a downlink radio resource control (RRC) configuration, reception in the flexible resources of a physical downlink control channel (PDCCH), reception in the flexible resources of a downlink positioning reference signal (DL-PRS), transmission in the uplink resources or the flexible resources of uplink data triggered by an uplink DCI, transmission in the flexible resources of uplink data triggered by an uplink RRC configuration in response to an enabled configured uplink configuration, and transmission in the uplink resources of uplink data triggered by an uplink RRC configuration.

Clause 12. The apparatus of clause 1 or clause 11, wherein the plurality of behaviors based on the detected absence of the DCI includes: reception in the flexible resources of downlink data triggered by a downlink DCI, refrained reception in the flexible resources of downlink data triggered by a downlink radio resource control (RRC) configuration, reception in the flexible resources of a physical downlink control channel (PDCCH), reception in the flexible resources of a downlink positioning reference signal (DL-PRS), transmission in the uplink resources or the flexible resources of uplink data triggered by an uplink DCI, transmission in the flexible resources of uplink data triggered by an uplink RRC configuration based on an enabled configured uplink configuration, and transmission in the uplink resources of uplink data triggered by an uplink RRC configuration based on an SBFD enabled configured uplink configuration.

Clause 13. The apparatus of any of clauses 1, 11, and 12, wherein the plurality of behaviors based on the detected absence of the DCI includes: refrained reception or transmission of data in the flexible resources, transmission in the uplink resources of uplink data triggered by an uplink DCI, and transmission in the uplink resources of uplink data triggered by an uplink radio resource control (RRC) configuration in response to a detected absence of a downlink DCI scheduling downlink data in the flexible resources or based on an SBFD enabled configured uplink configuration.

Clause 14. The apparatus of any of clauses 1 to 13, wherein whether the SFI indicates a slot format for only the flexible resources, or whether the SFI indicates the slot format for the SBFD symbol including both the flexible resources and the uplink resources, is based on a radio resource control (RRC) configuration parameter or a field in the DCI.

Clause 15. The apparatus of any of clauses 1 to 14, wherein the DCI is monitored in the set of SBFD symbols, and the SFI is configured to indicate the downlink format, the uplink format, or the flexible format for a subset of the set of SBFD symbols, the subset including the SBFD symbol.

Clause 16. A method of wireless communication performable at a user equipment (UE), comprising: monitoring for downlink control information (DCI) including a slot format indication (SFI) for a set of sub-band full duplex (SBFD) symbols in a slot, the set of SBFD symbols respectively being associated with flexible resources in at least one flexible sub-band and uplink resources in an uplink (UL) sub-band, and the SFI being configured to indicate a downlink format, an uplink format, or a flexible format for one of: only the flexible resources associated with a SBFD symbol of the set of SBFD symbols, or the SBFD symbol including both the flexible resources and the uplink resources; and receiving or transmitting, or refraining from receiving or transmitting, data in the SBFD symbol according to at least one of a plurality of behaviors respectively based on a detected presence or a detected absence of the DCI.

Clause 17. The method of clause 16, further comprising: refraining from receiving or transmitting SBFD-specific data in the SBFD symbol in response to the SFI being configured to indicate the flexible format, the downlink format, or the uplink format for the SBFD symbol including both the flexible resources and the uplink resources.

Clause 18. The method of clause 16 or clause 17, wherein whether the SFI indicates a slot format for only the flexible resources, or whether the SFI indicates the slot format for the SBFD symbol including both the flexible resources and the uplink resources, is based on a radio resource control (RRC) configuration parameter or a field in the DCI.

Clause 19. The method of any of clauses 16 to 18, wherein the DCI is monitored in the set of SBFD symbols, and the SFI is configured to indicate the downlink format, the uplink format, or the flexible format for a subset of the set of SBFD symbols, the subset including the SBFD symbol.

Clause 20. An apparatus for wireless communication, comprising: means for monitoring for downlink control information (DCI) including a slot format indication (SFI) for a set of sub-band full duplex (SBFD) symbols in a slot, the set of SBFD symbols respectively being associated with flexible resources in at least one flexible sub-band and uplink resources in an uplink (UL) sub-band, and the SFI being configured to indicate a downlink format, an uplink format, or a flexible format for one of: only the flexible resources associated with a SBFD symbol of the set of SBFD symbols, or the SBFD symbol including both the flexible resources and the uplink resources; and means for receiving or transmitting, or for refraining from receiving or transmitting, data in the SBFD symbol according to at least one of a plurality of behaviors respectively based on a detected presence or a detected absence of the DCI.

What is claimed is:

1. An apparatus for wireless communication, comprising:
one or more memories; and
one or more processors each communicatively coupled with at least one of the one or more memories, the one or more processors, individually or in any combination, operable to cause the apparatus to:
monitor for downlink control information (DCI) including a slot format indication (SFI) for a set of sub-band full duplex (SBFD) symbols in a slot, the set of SBFD symbols respectively being associated with flexible resources in at least one flexible sub-band and uplink resources in an uplink (UL) sub-band, and the SFI being configured to indicate a downlink format, an uplink format, or a flexible format for one of:
only the flexible resources associated with a SBFD symbol of the set of SBFD symbols, or
the SBFD symbol including both the flexible resources and the uplink resources; and
receive or transmit, or refrain from receiving or transmitting, data in the SBFD symbol according to at least one of a plurality of behaviors respectively based on a detected presence or a detected absence of the DCI.

2. The apparatus of claim 1, wherein in response to the SFI being configured to indicate the flexible format for the only the flexible resources, the plurality of behaviors based on the detected presence of the DCI includes:
reception in the flexible resources of downlink data triggered by a downlink DCI,
refrained reception in the flexible resources of downlink data triggered by a downlink radio resource control (RRC) configuration,
refrained reception in the flexible resources of a physical downlink control channel (PDCCH),
reception in the flexible resources of a downlink positioning reference signal (DL-PRS),
transmission in the uplink resources or the flexible resources of uplink data triggered by an uplink DCI,
refrained transmission in the flexible resources of uplink data triggered by an uplink RRC configuration, and
transmission in the uplink resources of uplink data triggered by an uplink RRC configuration in response to a detected absence of a downlink DCI scheduling downlink data in the flexible resources.

3. The apparatus of claim 1, wherein in response to the SFI being configured to indicate the downlink format for the only the flexible resources, the plurality of behaviors based on the detected presence of the DCI includes:
reception in the flexible resources of downlink data triggered by a downlink DCI,
reception in the flexible resources of downlink data triggered by a downlink radio resource control (RRC) configuration in response to a detected absence of an uplink DCI scheduling uplink data in the uplink resources,
reception in the flexible resources of a physical downlink control channel (PDCCH),
reception in the flexible resources of a downlink positioning reference signal (DL-PRS),
transmission in the uplink resources of uplink data triggered by an uplink DCI, and
transmission in the uplink resources of uplink data triggered by an uplink RRC configuration in response to a detected absence of a downlink DCI scheduling downlink data in the flexible resources.

4. The apparatus of claim 1, wherein in response to the SFI being configured to indicate the uplink format for the only the flexible resources, the plurality of behaviors based on the detected presence of the DCI includes:
refrained reception in the flexible resources of downlink data triggered by a downlink radio resource control (RRC) configuration,
refrained reception in the flexible resources of a downlink DCI for downlink data,
refrained reception in the flexible resources of a physical downlink control channel (PDCCH),
refrained reception in the flexible resources of a downlink positioning reference signal (DL-PRS),
transmission in the uplink resources of uplink data triggered by an uplink DCI, and
transmission in the uplink resources of uplink data triggered by an uplink RRC configuration.

5. The apparatus of claim 1, wherein in response to the SFI being configured to indicate the flexible format for the SBFD symbol including both the flexible resources and the uplink resources, the one or more processors, individually or in any combination, are operable to cause the apparatus to:
refrain from receiving or transmitting SBFD-specific data in the SBFD symbol.

6. The apparatus of claim 1, wherein in response to the SFI being configured to indicate the flexible format for the SBFD symbol including both the flexible resources and the uplink resources, the plurality of behaviors based on the detected presence of the DCI includes:
reception in the SBFD symbol of downlink data triggered by a downlink DCI,
refrained reception in the SBFD symbol of downlink data triggered by a downlink radio resource control (RRC) configuration,
refrained reception in the SBFD symbol of a physical downlink control channel (PDCCH),
reception in the SBFD symbol of a downlink positioning reference signal (DL-PRS),
transmission in the SBFD symbol of uplink data triggered by an uplink DCI, and
refrained transmission in the SBFD symbol of uplink data triggered by an uplink RRC configuration.

7. The apparatus of claim 1, wherein in response to the SFI being configured to indicate the downlink format for the SBFD symbol including both the flexible resources and the uplink resources, the one or more processors, individually or in any combination, are operable to cause the apparatus to:
refrain from receiving or transmitting SBFD-specific data in the SBFD symbol; and
receive only downlink data in the SBFD symbol.

8. The apparatus of claim 1, wherein in response to the SFI being configured to indicate the downlink format for the SBFD symbol including both the flexible resources and the uplink resources, the plurality of behaviors based on the detected presence of the DCI includes:
reception in the flexible resources of downlink data triggered by a downlink DCI,
reception in the flexible resources of downlink data triggered by a downlink radio resource control (RRC) configuration,
reception in the SBFD symbol of a physical downlink control channel (PDCCH),
reception in the SBFD symbol of a downlink positioning reference signal (DL-PRS), and
refrained reception in the SBFD symbol of an uplink DCI.

9. The apparatus of claim 1, wherein in response to the SFI being configured to indicate the uplink format for the SBFD symbol including both the flexible resources and the uplink resources, the one or more processors, individually or in any combination, are operable to cause the apparatus to:
refrain from receiving or transmitting SBFD-specific data in the SBFD symbol; and
transmit only uplink data in the SBFD symbol.

10. The apparatus of claim 1, wherein in response to the SFI being configured to indicate the uplink format for the SBFD symbol including both the flexible resources and the uplink resources, the plurality of behaviors based on the detected presence of the DCI includes:
transmission in the uplink resources of uplink data triggered by an uplink DCI,
transmission in the uplink resources of uplink data triggered by an uplink RRC configuration, and
refrained reception in the SBFD symbol of a downlink DCI.

11. The apparatus of claim 1, wherein the plurality of behaviors based on the detected absence of the DCI includes:
reception in the flexible resources of downlink data triggered by a downlink DCI,
refrained reception in the flexible resources of downlink data triggered by a downlink radio resource control (RRC) configuration,
reception in the flexible resources of a physical downlink control channel (PDCCH),
reception in the flexible resources of a downlink positioning reference signal (DL-PRS),
transmission in the uplink resources or the flexible resources of uplink data triggered by an uplink DCI,
transmission in the flexible resources of uplink data triggered by an uplink RRC configuration in response to an enabled configured uplink configuration, and
transmission in the uplink resources of uplink data triggered by an uplink RRC configuration.

12. The apparatus of claim 1, wherein the plurality of behaviors based on the detected absence of the DCI includes:
reception in the flexible resources of downlink data triggered by a downlink DCI,
refrained reception in the flexible resources of downlink data triggered by a downlink radio resource control (RRC) configuration,
reception in the flexible resources of a physical downlink control channel (PDCCH),
reception in the flexible resources of a downlink positioning reference signal (DL-PRS),
transmission in the uplink resources or the flexible resources of uplink data triggered by an uplink DCI,
transmission in the flexible resources of uplink data triggered by an uplink RRC configuration based on an enabled configured uplink configuration, and
transmission in the uplink resources of uplink data triggered by an uplink RRC configuration based on an SBFD enabled configured uplink configuration.

13. The apparatus of claim 1, wherein the plurality of behaviors based on the detected absence of the DCI includes:
refrained reception or transmission of data in the flexible resources,
transmission in the uplink resources of uplink data triggered by an uplink DCI, and
transmission in the uplink resources of uplink data triggered by an uplink radio resource control (RRC) configuration in response to a detected absence of a downlink DCI scheduling downlink data in the flexible resources or based on an SBFD enabled configured uplink configuration.

14. The apparatus of claim 1, wherein whether the SFI indicates a slot format for only the flexible resources, or whether the SFI indicates the slot format for the SBFD symbol including both the flexible resources and the uplink resources, is based on a radio resource control (RRC) configuration parameter or a field in the DCI.

15. The apparatus of claim 1, wherein the DCI is monitored in the set of SBFD symbols, and the SFI is configured to indicate the downlink format, the uplink format, or the flexible format for a subset of the set of SBFD symbols, the subset including the SBFD symbol.

16. A method of wireless communication performable at a user equipment (UE), comprising:
monitoring for downlink control information (DCI) including a slot format indication (SFI) for a set of sub-band full duplex (SBFD) symbols in a slot, the set of SBFD symbols respectively being associated with flexible resources in at least one flexible sub-band and uplink resources in an uplink (UL) sub-band, and the SFI being configured to indicate a downlink format, an uplink format, or a flexible format for one of:
only the flexible resources associated with a SBFD symbol of the set of SBFD symbols, or
the SBFD symbol including both the flexible resources and the uplink resources; and
receiving or transmitting, or refraining from receiving or transmitting, data in the SBFD symbol according to at least one of a plurality of behaviors respectively based on a detected presence or a detected absence of the DCI.

17. The method of claim 16, further comprising:
refraining from receiving or transmitting SBFD-specific data in the SBFD symbol in response to the SFI being configured to indicate the flexible format, the downlink format, or the uplink format for the SBFD symbol including both the flexible resources and the uplink resources.

18. The method of claim 16, wherein whether the SFI indicates a slot format for only the flexible resources, or whether the SFI indicates the slot format for the SBFD symbol including both the flexible resources and the uplink resources, is based on a radio resource control (RRC) configuration parameter or a field in the DCI.

19. The method of claim 16, wherein the DCI is monitored in the set of SBFD symbols, and the SFI is configured to indicate the downlink format, the uplink format, or the flexible format for a subset of the set of SBFD symbols, the subset including the SBFD symbol.

20. An apparatus for wireless communication, comprising:
means for monitoring for downlink control information (DCI) including a slot format indication (SFI) for a set of sub-band full duplex (SBFD) symbols in a slot, the set of SBFD symbols respectively being associated with flexible resources in at least one flexible sub-band and uplink resources in an uplink (UL) sub-band, and the SFI being configured to indicate a downlink format, an uplink format, or a flexible format for one of:
only the flexible resources associated with a SBFD symbol of the set of SBFD symbols, or
the SBFD symbol including both the flexible resources and the uplink resources; and
means for receiving or transmitting, or for refraining from receiving or transmitting, data in the SBFD symbol according to at least one of a plurality of behaviors respectively based on a detected presence or a detected absence of the DCI.
